SEQUENCE LISTING (21 sequences)

SEQ ID NO: 1 - protein, 521 aa, Bacillus amyloliquefaciens
MGLGKKLSVAVAASFMSLTISLPGVQAAENPQLKENLTNFVPKHSLVQSELPSVSDKAIKQYLKQNGKVFKGNPSERLKLIDQTTDDLGYKHFRYVPVVNGVPVKDSQVIIHVDKSNNVYAINGELNNDVSAKTANSKKLSANQALDHAYKAIGKSPEAVSNGTVANKNKAELKAAATKDGKYRLAYDVTIRYIEPEPANWEVTVDAETGKILKKQNKVEHAATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 2 - protein, 300 aa, Bacillus pumilus
AAATGSGTTLKGATVPLNISYEGGKYVLRDLSKPTGTQIITYDLQNRQSRLPGTLVSSTTKTFTSSSQRAAVDAHYNLGKVYDYFYSNFKRNSYDNKGSKIVSSVHYGTQYNNAAWTGDQMIYGDGDGSFFSPLSGSLDVTAHEMTHGVTQETANLIYENQPGALNESFSDVFGYFNDTEDWDIGEDITVSQPALRSLSNPTKYNQPDNYANYRNLPNTDEGDYGGVHTNSGIPNKAAYNTITKLGVSKSQQIYYRALTTYLTPSSTFKDAKAALIQSARDLYGSTDAAKVEAAWNAVGL

SEQ ID NO: 3 - protein, 520 aa, Bacillus amyloliquefaciens
MGLGKKLSVAVAASFMSLTISLPGVQAAENPQLKENLTNFVPKHSLVQSELPSVSDKAIKQYLKQNGKVFKGNPSERLKLIDQTTDDLGYKHFRYVPVVNGVPVKDSQVIIHVDKSNNVYAINGELNNDVSAKTANSKKLSANQALDHAYKAIGKSPEAVSNGTVANKNKAELKAAATKDGKYRLAYDVTIRYIEPEPANWEVTVDAETGKILKKQNKVEHAATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 4 - protein, 547 aa, Bacillus thermoproteolyticus
MKMKMKLASFGLAAGLAAQVFLPYNALASTEHVTWNQQFQTPQFISGDLLKVNGTSPEELVYQYVEKNENKFKFHENAKDTLQLKEKKNDNLGFTFMRFQQTYKGIPVFGAVVTSHVKDGTLTALSGTLIPNLDTKGSLKSGKKLSEKQARDIAEKDLVANVTKEVPEYEQGKDTEFVVYVNGDEASLAYVVNLNFLTPEPGNWLYIIDAVDGKILNKFNQLDAAKPGDVKSITGTSTVGVGRGVLGDQKNINTTYSTYYYLQDNTRGGIFTYDAKYRTTLPGSLWADADNQFFASYDAPAVDAHYYAGVTYDYYKNVHNRLSYDGNNAAIRSSVHYSQGYNNAFWNGSQMVYGDGDGQTFIPLSGGIDVVAHELTHAVTDYTAGLIYQNESGAINEAMSDIFGTLVKFYANKNPDWEIGEDVYTPGISGDSLRSMSDPAKYGDPDHYSKRYTGTQDNGGVHINSGIINKAAYLISQGGTHYGVSVVGIGRDKLGKIFYRALTQYLTPTSNFSQLRAAAVQSATDLYGSTSQEVASVKQAFDAVGVK

SEQ ID NO: 5 - protein, 314 aa, Penicillium oxalicum
MVCHSLAPFVVLVTSLFFLQAKCSPVVFEQRGICATEDPDTSFLDALERVRTDETQLPDTGSEARNGPIEIETWFHIITSKAEQDQVSDDMIESQISILQDAYQDAGIQYRLQGVTRHVNDVWARNGDDTGMKSALRKGTYRTLNVYFQTDLQASPDQAGRASHRGASHSSDLSSSVLGFCTLPDPSVNATSPRADYIKDGCNVLASAMSGGTLDLYNRGGTAIHEIGHWNGLLHTFQGESCAEDNPGDYIADTPQQSVPTGGCPARKDSCPNLPGQDPIHDFMDYSSDVCYESFTPGQNERMRNMWASMRAGK

SEQ ID NO: 6 - DNA, 1023 bp, Penicillium oxalicum
atggtctgtcactctttagctccgttcgtggttcttgtcacatctctctttttcttgcaagcgaaatgcagccccgtggtgtttgaacagcgtggcatctgcgctaccgaagatccagatacgtccttcttggacgcactcgagcgtgtcagaacagatgagacccagctacctgacactgggtcagaggcccgcaacggccccatcgagattgagacctggttccatatcatcaccagcaaagcagagcaagaccaggtttctgatgacatgatcgagtcccaggtaagtcctacctccatcgctcctgttctcgacgacttcaatcgcatgtcatgaacgaatgctaagacactcgcctagatctccattctacaagatgcgtatcaggatgccggtattcaatatcgactgcaaggtgtcacccgccatgtgaacgatgtttgggctcgcaacggagatgacacaggcatgaagtcagcccttcgaaaagggacctatcggactctaaacgtttacttccaaaccgacctccaggcatcacccgaccaagccggtcgtgcaagccaccgcggagcttctcattcaagtgatctctcatccagcgtgctaggattctgcaccctccccgatccaagcgtgaatgccaccagtccccgtgccgactacattaaggatggctgcaacgttctcgctagcgcgatgtccggaggcacattggacctttacaaccgaggaggaaccgccatccacgagatcggacattggaatggccttttgcataccttccaaggggagtcctgtgccgaggataatccaggggactacattgccgacacgccccaacaatctgtcccaactggcggatgccctgctcgaaaggattcttgtcccaatttgccggggcaggaccccatccacgactttatggactactcatctgatgtctgttatgagagttttacacctggtcagaatgaacgtatgcgaaatatgtgggcatcgatgcgtgcagggaaatag

SEQ ID NO: 7 - protein, 318 aa, Aspergillus oryzae
MSHFPTLHILILVIANLQIQCFAFVSQSRGFCATGPPTESLKAEYRRLSALGSQSYNPVDSESRAAITPIVIDTWFHIITGEAGTELISDEMIADQLSYLQNAYWNATISYRLQGVTRSANDTWARNEDEMAMKTVLRRGSYRTLNVYFHTDLQASPNAGARAFDIVRRELGVSQQQPTSMLGFCTLPDPSINASSPPSTYIKDGCNVLAETMPGGSLAHYNRGGTAIHEIGHWNGLLHTFEGESCSSDNEGDFIADTPQQSKPTEGCPAQKDSCPELPGFDAIHNFMDYSSDECYDSFTPDQVSRMRSMWFAMRDGK

SEQ ID NO: 8 - DNA, 1908 bp, Bacillus amyloliquefaciens
gatcttaacatttttcccctatcatttttcccgtcttcatttgtcattttttccagaaaaaatcgcgtcattcgactcatgtctaatccaacacgtgtctctcggcttatcccctgacaccgcccgccgacagcccgcatgggacgattctatcaattcagccgcggagtctagttttatattgcagaatgcgagattgctggtttattataacaatataagttttcattattttcaaaaagggggatttattgtgggtttaggtaagaaattgtctgttgctgtcgccgcttcctttatgagtttaaccatcagtctgccgggtgttcaggccgctgagaatcctcagcttaaagaaaacctgacgaattttgtaccgaagcattctttggtgcaatcagaattgccttctgtcagtgacaaagctatcaagcaatacttgaaacaaaacggcaaagtctttaaaggcaatccttctgaaagattgaagctgattgaccaaacgaccgatgatctcggctacaagcacttccgttatgtgcctgtcgtaaacggtgtgcctgtgaaagactctcaagtcattattcacgtcgataaatccaacaacgtctatgcgattaacggtgaattaaacaacgatgtttccgccaaaacggcaaacagcaaaaaattatctgcaaatcaggcgctggatcatgcttataaagcgatcggcaaatcacctgaagccgtttctaacggaaccgttgcaaacaaaaacaaagccgagctgaaagcagcagccacaaaagacggcaaataccgcctcgcctatgatgtaaccatccgctacatcgaaccggaacctgcaaactgggaagtaaccgttgatgcggaaacaggaaaaatcctgaaaaagcaaaacaaagtggagcatgccgccacaaccggaacaggtacgactcttaaaggaaaaacggtctcattaaatatttcttctgaaagcggcaaatatgtgctgcgcgatctttctaaacctaccggaacacaaattattacgtacgatctgcaaaaccgcgagtataacctgccgggcacactcgtatccagcaccacaaaccagtttacaacttcttctcagcgcgctgccgttgatgcgcattacaacctcggcaaagtgtatgattatttctatcagaagtttaatcgcaacagctacgacaataaaggcggcaagatcgtatcctccgttcattacggcagcagatacaataacgcagcctggatcggcgaccaaatgatttacggtgacggcgacggttcattcttctcacctctttccggttcaatggacgtaaccgctcatgaaatgacacatggcgttacacaggaaacagccaacctgaactacgaaaatcagccgggcgctttaaacgaatccttctctgatgtattcgggtacttcaacgatactgaggactgggatatcggtgaagatattacggtcagccagccggctctccgcagcttatccaatccgacaaaatacggacagcctgataatttcaaaaattacaaaaaccttccgaacactgatgccggcgactacggcggcgtgcatacaaacagcggaatcccgaacaaagccgcttacaatacgattacaaaaatcggcgtgaacaaagcggagcagatttactatcgtgctctgacggtatacctcactccgtcatcaacttttaaagatgcaaaagccgctttgattcaatctgcgcgggacctttacggctctcaagatgctgcaagcgtagaagctgcctggaatgcagtcggattgtaaacaagaaaagagaccggaaatccggtctcttttttatatctaaaaacatttcacagtggcttcaccatgatcatatatgtcttttcccg

SEQ ID NO: 9 - protein, 521 aa, Bacillus subtilis
  misc_feature (338)..(338): Xaa can be any naturally occurring amino acid
MGLGKKLSVAVAASFMSLTISLPGVQAAENPQLKENLTNFVPKHSLVQSELPSVSDKAIKQYLKQNGKVFKGNPSERLKLIDHTTDDLGYKHFRYVPVVNGVPVKDSQVIIHVDKSNNVYAINGELNNDASAKTANSKKLSANQALDHAFKAIGKSPEAVSNGNVANKNKAELKAAATKDGKYRLAYDVTIRYIEPEPANWEVTVDAETGKVLKKQNKVEHAAATGTGTTLKGKTVSLNISSENGKYVMRDLSKPTGTQIITYDLQNRQYNLPGTLVSSTTNQFTTSSQRAAVDAHYNLGKVYDYFYQTFKRNSYDNRGGKIVSSVHYGSRYNNAAWXGDQMIYGDGDGSFFSPLSGSMDVTAHEMTHGVTQETANLNYENQPGALNESFSDVFGYFTDTEDWDIGEDITVSQPALRSLSNPTKYGQPDHYKNYQNLPNTDAGDYGGVHTNSGIPNKAAYNTITKIGVKKAEQIYYRALTVYLTPSSSFKDAKAALIQSARDLYGSQDAASVEAAWNAVGL

SEQ ID NO: 10 - protein, 354 aa, Elizabethkingia miricola
MRKLLIFSISAYLMAGIVSCKGVDSATPVTEDRLALNAVNAPADNTVNIKTFDKVKNAFGDGLSQSAEGTFTFPADVTTVKTIKMFIKNECPNKTCDEWDRYANVYVKNKTTGEWYEIGRFITPYWVGTEKLPRGLEIDVTDFKSLLSGNTELKIYTETWLAKGREYSVDFDIVYGTPDYKYSAVVPVIQYNKSSIDGVPYGKAHTLGLKKNIQLPTNTEKAYLRTTISGWGHAKPYDAGSRGCAEWCFRTHTIAINNANTFQHQLGALGCSANPINNQSPGNWAPDRAGWCPGMAVPTRIDVLNNSLTGSTFSYEYKFQSWTNNGTNGDAFYAISSFVIAKSNTPISAPVVTN

SEQ ID NO: 11 - protein, 567 aa, Elizabethkingia meningoseptica
MLFFLPLLKTNLMQKILLCSLITGAQMIFAQTYEITYQNSFEGKINPNQNHIISITNSDKTLLFNEKIKNKKADFPFEVNEINRKNNEVSQFAFLNNNEIVKTSDNTILAKQEFKPTSETGKILGYNVKKAVTSVNSNTIEVWYTNDLKVKGGPSILGQDLGLVLKTVRNGSSVVEATSVKKIKALDDQSLFNGKNITEKDALTYKDMIWKSRFITIPVFENETINFSDASKSDQVIQRFGNGTIILKKVKIPEIKQGNTIFVELKQKSNGDAYDRTGDVFIIPQERAISYYTGLTQGVKSLPVYQNGNGKSYQGVALTPDYLPFIELMRFFTPFGIGHFNEKIQLKGKNWHNNTPYRQDITELRPQLSGKEILIGAFIGNYDKGGHQISLELSIHPDQQKIVNNNFVLPVFNTTNVMEMAGQDYPTMFNSDKGVEVEFILTKDLKNAQLRYITTGHGGWGAGDEFVPKENSIYLDGKLAHAFTPWRTDCGSYRLFNPASGNFEDGLSSSDLSRSNWCPGTITNPVYINLGNLNAGKHTIQVKIPQGAPEGSSQSFWNVSGVLLGQE

SEQ ID NO: 12 - protein, 313 aa, Streptomyces plicatus
MFTPVRRRVRTAALALSAAAALVLGSTAASGASATPSPAPAPAPAPVKQGPTSVAYVEVNNNSMLNVGKYTLADGGGNAFDVAVIFAANINYDTGTKTAYLHFNENVQRVLDNAVTQIRPLQQQGIKVLLSVLGNHQGAGFANFPSQQAASAFAKQLSDAVAKYGLDGVDFDDEYAEYGNNGTAQPNDSSFVHLVTALRANMPDKIISLYNIGPAASRLSYGGVDVSDKFDYAWNPYYGTWQVPGIALPKAQLSPAAVEIGRTSRSTVADLARRTVDEGYGVYLTYNLDGGDRTADVSAFTRELYGSEAVRTP

SEQ ID NO: 13 - protein, 243 aa, Schistosoma japonicum
MIFYRLLGLIFILETIILISSNVYGLDNGLARTPPMGWMTWQRFRCQIDCKEYPNDCINENLIKRTADKLVLNGWRDLGYKYVIIDDCWPARKRDSKTNELVPDPDRFPNGMKNVGEYLHSKNLLFGIYLDYGTLTCEGYPGSMNYLELDARSIAEWKVDYVKMDGCYSLPNIQPEGYENFSRLLNTTGRPMVFSCSYPAYISWINNIKLIDWNRLKKNCNLWRVLGDIQDSLSSVVSIIKCL

SEQ ID NO: 14 - protein, 592 aa, Paenibacillus polymyxa
MKKVWFSLLGGAMLLGSVASGASAESSVSGPAQLTPTFHAEQWKAPSSVSGDDIVWSYLNRQKKSLLGVDSSSVREQFRIVDRTSDKSGVSHYRLKQYVNGIPVYGAEQTIHVGKSGEVTSYLGAVINEDQQEEATQGTTPKISASEAVYTAYKEAAARIEALPTSDDTISKDAEEPSSVSKDTYAEAANNDKTLSVDKDELSLDKASVLKDSKIEAVEAEKSSIAKIANLQPEVDPKAELYYYPKGDDLLLVYVTEVNVLEPAPLRTRYIIDANDGSIVFQYDIINEATGTGKGVLGDSKSFTTTASGSSYQLKDTTRGNGIVTYTASNRQSIPGTLLTDADNVWNDPAGVDAHAYAAKTYDYYKSKFGRNSIDGRGLQLRSTVHYGSRYNNAFWNGSQMTYGDGDGSTFIAFSGDPDVVGHELTHGVTEYTSNLEYYGESGALNEAFSDVIGNDIQRKNWLVGDDIYTPNIAGDALRSMSNPTLYDQPDHYSNLYKGSSDNGGVHTNSGIINKAYYLLAQGGTFHGVTVNGIGRDAAVQIYYSAFTNYLTSSSDFSNARAAVIQAAKDLYGANSAEATAAAKSFDAVGVN

SEQ ID NO: 15 - protein, 504 aa, Serratia liquefaciens
MSICLIENNQLMSGIEPMQSTKKAIEITESSLAAAGSGYNAVDDLLHYHERGNGIQVNGKDSFSTEQAGLFITRENQTWNGYKVFGQPVKLTFSFPDYKFSSTNVAGDTGLSKFSAEQQQQAKLSLQSWSDVANITFTEVGAGQKANITFGNYSQDRPGHYDYDTQAYAFLPNTIYQGQNLGGQTWYNVNQSNVKHPASEDYGRQTFTHEIGHALGLSHPGDYNAGEGNPTYRDASYAEDTREFSLMSYWSETNTGGDNGGHYAAAPLLDDISAIQHLYGANLTTRTGDTVYGFNSNTGRDFLSTTSNSQKVIFAAWDAGGNDTFDFSGYTANQRINLNEKSFSDVGGLKGNVSIAAGVTIENAIGGSGNDVIVGNAANNVLKGGAGNDVLFGGGGADELWGGAGKDTFVFSAVSDSAPGASDWIKDFQKGIDKIDLSFFNQGAQGGDQIHFVDHFSGAAGEALLSYNASNNVSDLALNIGGHQAPDFLVKIVGQVDVATDFIV

SEQ ID NO: 16 - protein, 369 aa, Aspergillus niger
MSARNNHTYTFIQPQILQHISTSPNASSKARRAATRTLTLANEIHQTRVSSSPYISLTSHAQAREIYDCRNKRGLPGLLVRTESSSAPTTQDDTVNHVYNSFGIFLHFLSSVLGRQSIDNDNLRLIGCLHYDKNLDNAFWNGQEIIFGDGDGVYFAGFPKSLDVVVHELMHGVTDHTAGLLYEGQSGALSESISDVFACVIEQWWRGQGVEEADWVVGRGVFVWPKGKKGAGAGAGEMGLRSLKAPGTAYDDPVLGRDGQPSHMKELVCTEEDNGGVHWNSGIPSHAFYLCAVEFGGRSWEKAAIVWYRALLDPRVEPNCSFQRFASVTVDIAEAMFGGEAGEVVKRAWVAVGVEVGMVLWTVKGDTGC

SEQ ID NO: 17 - protein, 375 aa, Aspergillus terreus
MAHLCAFVPQYVLEGIVEKGLAPEHIINRCQSTIDKTTQLRDTRGRHVQSIAAAQQQRISQGIIPPYILESIARNPATEQQREAARHTLALSTKHRTAAARGGKLLSEAEDPTNNANECYNGLGKSYDFYFNFFQRNSVDDNGFELDGFVHAGDLYNAYWDGYELVFGDGDGVIFDGFTDELDVIGHEFSHGVVEHTSPLPYAFQSGALNESLADAFGVMIKQWGEGTPKTVDQADWLVGEGIWAEGVNGRALRDMANPGTAYDDPRVGKDPQPAHWKDFKKLSASDDEGGVHINSGIPNRAFYLAATKIGGYAWEGAGAIWYRALASGKLRKDGKAKFKDFADLTIENAGEHVDKVREAWTLVGYPFAEERHEL

SEQ ID NO: 18 - protein, 319 aa, Aspergillus kawachii
MTLLLNLHALFTAIVFANLSTRCSALLSGRDFCSTPAPDESLRAEHRRLYDLQAQRGSTAEESREVVSMIEIETWFHIVSSNEASNAVSDDMITSQLSYLQKAYESATISYRLEGITRHINDSWARNDDELGMKNALRRGIYSTLNVYFQTDLQASSDDTSRGFPYNGNRRTDVSGQSSTTVLGFCTLPDPSVNSSSPRSSYIKDGCNVLADTMPGGSLAQYNQGGTAVHEVGHWNGLLHTFEGESCSPDNEGDYIDDTPEQSEPTSGCPAEKDSCPDLPGLDAIHNFMDYSSDDCYESFTPDQAERMRSMWSAMREGK

SEQ ID NO: 19 - protein, 318 aa, Aspergillus oryzae; identical to SEQ ID NO: 7

SEQ ID NO: 20 - protein, 311 aa, Penicillium roqueforti
MVCHSFFQLVIFITVFLQAWCSPFALQKRGACATEDPGANFLHEVRRLQSDEADLAISQARKAPIEIETWFHIISSKSESTQVTDNMINSQFSILQQSYADSGISYRLQGVTRNVNDKWASNADDTAMKTTLRKGSYRTLNVYFQTDLQASPEQAGRAFGHRGAVTNNDLASSVLGFCTLPDPSVNASSPASQYIKDGCNVLAKTMPGGSLDLYNRGGTAIHEIGHWNGLLHTFQGESCSVDNPGDHISDTPQQSTPTDGCPDQKDSCPDSPGLDAVHDFMDYSSDVCYERFTPGQGERMRSMWISMREGK

SEQ ID NO: 21 - protein, 6 aa, Artificial Sequence
  Fluorogenic peptide
  MISC_FEATURE (1)..(1): Abz group
  MISC_FEATURE (6)..(6): Anb group
AAFFAA

(19) United States
(12) Patent Application Publication
(10) Pub. No.: US 2017/0367360 A1
(43) Pub. Date: Dec. 28, 2017

(54) METHOD

(71) Applicant: DUPONT NUTRITION BIOSCIENCES APS, Copenhagen K (DK)

(72) Inventors: Shukun Yu, Malmo (SE); Thomas Eisele, Horning (DE); Charlotte Horsmans Poulsen, Brabrand (DE); Hans Christian Bejder, Brabrand (DE)

(21) Appl. No.: 15/544,770

(22) PCT Filed: Jan. 28, 2016
(86) PCT No.: PCT/US2016/015337

§ 371 Date: Jul. 19, 2017

Related U.S. Application Data
(60) Provisional application No. 62/193,738, filed on Jul. 17, 2015.

(30) Foreign Application Priority Data
Jan. 30, 2015 (GB) 1501565.4

(51) Int. Cl. A23C 9/12; A23C 9/127; A23C 13/16

(52) U.S. Cl. CPC A23C 9/1209; C12Y 304/24; C12Y 304/21; C12Y 304/17; A23C 9/1206; A23C 13/16; A23C 9/127; C12Y 302/01

(57) ABSTRACT

The present invention relates to a method of preparing a fermented milk product. The method comprises the steps of treating a milk substrate with a low pH sensitive peptidase and a microorganism, and allowing the treated milk substrate to ferment to produce the fermented milk product.

### CROSS-REFERENCE TO RELATED APPLICATIONS

THIS APPLICATION CLAIMS PRIORITY TO AND THE BENEFIT OF UNITED KINGDOM PATENT APPLICATION NUMBER 1501565.4, TITLED “METHOD,” FILED Jan. 30, 2015, AND U.S. PROVISIONAL PATENT APPLICATION No. 62/193,738 TITLED “METHOD”, FILED Jul. 17, 2015.

### INCORPORATION BY REFERENCE OF THE SEQUENCE LISTING

The sequence listing provided in the file named “20160126_NB40714PCT_ST25.txt” with a size of 68,480 bytes which was created on Jan. 26, 2016 and which is filed herewith, is incorporated by reference herein in its entirety.

### FIELD OF THE INVENTION

The present invention relates to a method of preparing a fermented milk product. The method comprises the steps of treating a milk substrate with a low pH sensitive peptidase and a microorganism, and allowing the treated milk substrate to ferment to produce the fermented milk product.

### BACKGROUND

Yogurt is a milk curd produced all over the world, obtained by a lactic fermentation of a milk base enriched with milk proteins, and sometimes sugars and thickeners (Sodini et al. (2004). Critical Reviews in Food Science and Nutrition, 44(2), pp 113-137). One of the most important quality attributes for yogurt is texture. The texture can be modified by adding proteins such as caseinate or milk serum proteins, by adding texturizing agents (thickeners, gelling agents) such as starch, pectin or gelatin or other food grade polymers, or by taking advantage of in-situ produced exopolysaccharides (EPS) (US 2005/0095317 to Queguiner, et al.). The addition of hydrocolloids originating from plant and animal sources (pectin, guar gum, locust bean gum, gelatin, casein) to fermented dairy products is prohibited in some countries and the quantities available are not sufficient to fulfil the demand (Prasanna et al. (2012) Food Research International, 47(1), pp 6-12.). Accordingly, there is a need for further improved texture modifiers for use in milk products, in particular for use in fermented milk products such as yogurt.

Lactic acid bacteria (LAB) capable of synthesizing EPS have long been used in food processing to improve physical properties and texture of fermented products such as yogurt and milk based desserts, cheese, and sour dough bread (Mende et al. (2013) Food Hydrocolloids, 32(1), pp 178-185). The mechanisms by which EPS impact milk gel properties are still not fully understood, but have been frequently associated with their structural characteristics, for example monosaccharide composition, charge, molar mass, degree of branching, chain stiffness, and also with their molecular interactions with milk proteins (Mende et al., (2013)). Furthermore chymosin, a highly specific aspartic endopeptidase which is employed for cheese manufacturing, can be applied to texturize fresh fermented products. Certain caseinolytic enzymes like chymosin were known because of their coagulating effect to induce substantial phenomena of syneresis (exudation of milk serum), which is not desirable during the manufacture of yogurt and fermented milks (Queguiner et al., supra and US2005/0095316 to De Greeftrial et al.). US 2005/0095317 further demonstrates, that the proteolysation of caseins, at least kappa-casein, improves the texture and increases the viscosity of yogurts and fermented milks, without inducing syneresis as a result. But the kappa-caseinolysis should be carried out in a controlled manner, that is to say that the primary proteolysis reaction should not continue hydrolyzing the casein into its different amino acids and their oligomer, but should be halted after hydrolyzing the casein into fragments of the size of a peptide, a polypeptide or a protein otherwise a bitter taste may result (Queguiner et al., supra). Most recently, it has been reported that N- and O-linked glycosidases increase the viscosity of fresh fermented products as well (WO2012/069546A1 to Jakobsen et al.). WO2012/069546A1 shows that the gel firmness and viscosity of fresh fermented products can be improved by removing glycans by deglycosylation.

Accordingly, there is a need for easy to use texture modifiers which are easy to source, improve texture without syneresis, can be used in conjunction with glycosidases, comply with cultural and ethical needs (for example, vegetarianism), and do not cause the milk product or fermented milk product to become distasteful.

### SUMMARY

In a broad aspect, the present invention provides a method of providing a milk product, specifically a fermented milk product.

In particular, the present invention provides a method of providing a fermented milk product, the method comprising: (a) treating a milk substrate with a low pH sensitive peptidase and a microorganism; and (b) allowing the treated milk substrate to ferment to produce the fermented milk product.

In a preferred embodiment, the low pH sensitive peptidase is a metalloprotease.

In a preferred embodiment, the low pH sensitive peptidase is not a chymosin or chymosin-like enzyme.

In a most preferred embodiment, the low pH sensitive peptidase used in the method of the present invention is a metalloprotease and belongs to Enzyme Commission (E.C.) No. 3.4.17 or 3.4.24 and/or is from the M4 family.

In a most preferred embodiment, the present invention provides a method of providing a fermented milk product, the method comprising (a) treating a milk substrate with a low pH sensitive peptidase and a microorganism; and (b) allowing the treated milk substrate to ferment to produce the fermented milk product; and wherein the low pH sensitive peptidase is a bacteria peptidase, a fungal peptidase, an archaeal peptidase or an artificial peptidase.

In a most preferred embodiment, the present invention provides a method of providing a fermented milk product, the method comprising: (a) treating a milk substrate with a low pH sensitive peptidase and a microorganism; and (b) allowing the treated milk substrate to ferment to produce the fermented milk product; and wherein the low pH sensitive peptidase is a metalloprotease. In a preferred embodiment said metalloprotease is a bacteria metalloprotease, a fungal metalloprotease, an archaeal metalloprotease or an artificial metalloprotease.

Preferably, the low pH sensitive peptidase is a food grade peptidase. Preferably, the low pH sensitive peptidase has GRAS (generally regarded as safe) status. Most preferably, the low pH sensitive peptidase is NP7L. In a preferred embodiment NP7L is obtained from or obtainable from Bacillus amyloliquefaciens. Preferably NP7L comprises the amino acid sequence of SEQ ID NO: 1, or has at least 75% sequence identity thereto.

In another aspect of the invention a fermented milk product is provided obtained by the present methods. Preferably, said fermented milk product is fermented milk, a yogurt, a stirred yogurt or a set yogurt.

In a further aspect, a use of a low pH sensitive peptidase is provided in the production of a fermented milk product, wherein said fermented milk product has one or more of the following features:

(a) improved viscosity;
(b) improved gel strength;
(c) improved texture;
(d) improved firmness of curd;
(e) earlier onset of fermentation;
(f) earlier onset of gelation;
(g) earlier conclusion of fermentation;
(h) reduced syneresis;
(i) improved shelf life;
(j) reduced stickiness; or
(k) any combination of (a) to (i).

### SOME ADVANTAGES

The methods of the invention are advantageous in that they provide a fermented milk product with improved taste and/or mouthfeel due to one of more of the following improvements:—improved viscosity, improved gel strength, improved texture, improved firmness of curd, earlier onset of fermentation, earlier onset of gelation, earlier conclusion of fermentation, reduced syneresis, and/or increased shelf life.

Enzymes such as proteases which remain active in a food product during storage, specifically in a fermented milk product, continue to further hydrolyze the food. This is known to destroy the texture, decrease viscosity, and produce bitter peptides. Therefore, such proteases dramatically reduce the length of time a product may be stored before spoilage. In other words, the shelf life is decreased. Furthermore, active enzyme left in the food may require special labelling in order to meet food standard requirements.

The current invention encompasses a fermented milk product prepared using a low pH sensitive peptidase. In a preferred embodiment, said peptidase is a metalloprotease.

In a preferred embodiment, the low pH sensitive peptidase used in the present compositions and methods is an exogenous peptidase. The term “exogenous” as used herein means that the peptidase is not naturally present in milk. The low pH sensitive peptidase must therefore be added to the milk substrate.

In a further preferred embodiment, the exogenous low pH sensitive peptidase is not naturally present and/or produced by the microorganism used to ferment the treated milk substrate.

Preferably, during fermentation the production of organic acids (e.g. lactic acid) lowers the pH and deactivates the low pH sensitive peptidases during the methods of the invention. Therefore proteolytic activity ceases before or during storage, and the texture, viscosity and taste changes seen when other proteases are used does not occur.

Metalloproteases are dependent on metal divalent ions for activity stability and these metal ions are easily disassociated. In particular, the metal ions are lost if there is a decrease in pH. Therefore metalloproteases are deactivated during fermentation.

Furthermore, the low pH sensitive peptidases for use in the method of the current invention do not need to be animal derived. This allows consumers with diets such as vegetarian, vegan, kosher and Halal to consume the resulting products.

The current invention also allows the production of less sour fermented milk products, particularly yogurts, which may contain less protein. Fermentation may cease earlier in production, thus lowering production costs and time taken to produce the fermented milk product. The fermented milk product in addition still have one or more of the features of improved viscosity, improved gel strength, improved texture, improved firmness of curd, earlier onset of fermentation, earlier onset of gelation, earlier conclusion of fermentation, reduced syneresis, reduced stickiness and/or increased shelf life.

### FIGURES

FIG. 1: A Graphical illustration of the effect of NP7L addition on shear stress of stirred yogurt after 14 days of storage applying YO-Mix 465. (100 ml scale, 43° C., pH=4.6, standardised skim milk (4% protein, 0.1% fat)).

FIG. 2: A Graphical illustration of the effect of NP7L addition on shear stress of stirred yogurt after 5 days of storage applying YO-Mix 532. (100 ml scale, 43° C., pH=4.6, standardised skim milk (4% protein, 0.1% fat)).

FIG. 3: A Graphical illustration of the effect of NP7L addition on shear stress of stirred yogurt after 5 days of storage applying YO-Mix 860. (100 ml scale, 43° C., pH=4.6, standardised skim milk (4% protein, 0.1% fat)).

FIG. 4: A Graphical illustration of the effect of NP7L addition on shear stress of stirred yogurt after 5 days of storage applying YO-Mix 414. (100 ml scale, 43° C., pH=4.6, standardised skim milk (4% protein, 0.1% fat)).

FIG. 5: A Graphical illustration of the effect of NP7L addition on shear stress of stirred yogurt after 28 days of storage using the pilot plant equipment for stirring and cooling (5 l scale, YO-Mix 465, 43° C., pH=4.6, standardised skim milk (4% protein, 0.1% fat)).

FIG. 6: A Graphical illustration of the effect of NP7L addition on yogurt curd stiffness of set style yogurt after 5 days of storage. (100 ml scale, 43° C., pH=4.6, standardised skim milk (4% protein, 0.1% fat)).

FIG. 7: A Graphical illustration of the effect of NP7L addition on shear stress of stirred yogurt after 5 days of storage applying the mesophilic culture Probat 505. (100 ml scale, 27° C., pH=4.6, standardised skim milk (4% protein, 0.1% fat)).

FIG. 8: A Graphical illustration of the effect of NP7L addition on shear stress of stirred yogurt after 5 days of storage applying the mesophilic culture Choozit 220. (100 ml scale, 27° C., pH=4.6, standardised skim milk (4% protein, 0.1% fat)).

FIG. 9: A Graphical illustration of the effect of NP7L addition on shear stress of stirred yogurt after 5 days of storage applying the mesophilic culture Choozit 230. (100 ml scale, 27° C., pH=4.6, standardised skim milk (4% protein, 0.1% fat)).

FIG. 10: A Graphical illustration of the effect of NP7L addition on shear stress of stirred yogurt after 6 days of storage applying a fermentation temperature of 43° C. (100 ml scale, YO-Mix 465, 43° C., pH=4.6, standardised skim milk (4% protein, 0.1% fat)).

FIG. 11: A Graphical illustration of the effect of NP7L addition on shear stress of stirred yogurt after 6 days of storage applying a fermentation temperature of 37° C. (100 ml scale, YO-Mix 465, 37° C., pH=4.6, standardised skim milk (4% protein, 0.1% fat)).

FIG. 12: A Graphical illustration of the effect of NP7L addition on storage modulus of stirred yogurt after 6 days of storage applying a fermentation temperature of 37° C. (100 ml scale, YO-Mix 465, 37° C., pH=4.6, standardised skim milk (4% protein, 0.1% fat)).

FIG. 13: A Graphical illustration of the effect of NP7L addition on curd stiffness of set style yogurt after 5 days of storage applying different fermentation temperatures. (100 ml scale, 43, 37 and 30° C., pH=4.6, standardised skim milk (4% protein, 0.1% fat)).

FIG. 14: A Graphical illustration of the effect of NP7L addition on shear stress of stirred yogurt after 6 days of storage stopping the fermentation at pH 4.8 compared to the reference stopped at pH 4.6. (100 ml scale, YO-Mix 860, 43° C., standardised skim milk (4% protein, 0.1% fat)).

FIG. 15: A Graphical illustration of the effect of NP7L addition on shear stress of stirred yogurt after 5 days of storage applying different protein contents. (100 ml scale, YO-Mix 465, 37° C., standardised skim milk (0.1% fat)).

FIG. 16: A Graphical illustration of the effect of NP7L addition onset gelation of yogurt (40 ml scale, YO-Mix 465 43° C., standardised skim milk (4% protein, 0.1% fat)).

FIG. 17: A Graphical illustration of the effect of Protex 7 L and Marzyme 10 on a yoghurt compared to a control, after 1 day of storage.

FIG. 18: A Graphical illustration of the effect of NP14L on a yoghurt compared to a control, after 6 days of storage.

FIG. 19: A photograph of the test of fungal metalloprotease GOI269 for coagulating effect on milk protein of casein. Photos were taken after overnight incubation at 37° C.

FIG. 20: A photograph illustrating the results of Example 10, a test of fungal metalloprotease GOI269 coagulating effect on milk.

FIG. 21: (SEQ ID NO:1) The full amino acid sequence of NP7L from Bacillus amyloliquefaciens.

FIG. 22: (SEQ ID NO:2) The amino acid sequence of Bacillus pumilus (Bacillus mesentericus) Neutral protease NprE.

FIG. 23: (SEQ ID NO:3) The amino acid sequence of Bacillus amyloliquefaciens peptidase M4.

FIG. 24: (SEQ ID NO:4) The amino acid sequence of NP14L Bacillus thermoproteolyticus (SEQ ID NO:4).

FIG. 25: (SEQ ID NO:5) The full amino acid sequence of GOI269 from Penicillium oxalicum.

FIG. 26: (SEQ ID NO:6) The gene sequence of GOI269 from Penicillium oxalicum.

FIG. 27: (SEQ ID NO:7) The full amino acid sequence of a metalloprotease from Aspergillus oryzae.

FIG. 28: An alignment of the two metalloprotease sequences of Penicillium oxalicum and Aspergillus oryzae.

FIG. 29: (SEQ ID NO:8) The nucleotide sequence which encodes NP7L (SEQ ID NO:1).

FIG. 30: (SEQ ID NO:9) The amino acid sequence of Bacillus subtilis Neutral protease NprE.

FIG. 31: (SEQ ID NO:10) The amino acid sequences of PNGase A (Peptide-N(4)-(N-acetyl-beta-D-glucosaminyl) asparagine amidase F) from Elizabethkingia miricola (Chryseobacterium miricola)

FIG. 32: (SEQ ID NO:11) The amino acid sequence of PNGase F from Elizabethkingia meningoseptica (Chryseobacterium meningosepticum)

FIG. 33: (SEQ ID NO:12) The amino acid sequence of Endoglycosidase H (Endo-beta-N-acetylglucosaminidase H) from Streptomyces plicatus

FIG. 34: (SEQ ID NO:13) The amino acid sequence of N-acetyl galactosaminidase, alpha from Schistosoma japonicum

FIG. 35: A Graphical illustration of the quantification of active protein in NP7L using N-CBZ-glycine p-nitrophenyl ester in Example 1a.

FIG. 36: A Graphical illustration of the assay of NP7L at pH4.6 and 6.7, the pH of yogurt and fresh milk, respectively, using BVGApNA as substrate as per Example 1b.

FIG. 37: A Graphical illustration of assaying NP7L using Abz-AAFFAA-Anb as a substrate and monitoring fluorescence as per Example 1c (Key: Y=yogurt, Y+NP7L, yogurt that has been treated with NP7L, ng=nanogram active enzyme protein in 52.5 ul NP7L assay mixture).

FIG. 38: (SEQ ID NO:14) The amino acid sequence of Dispase (EC=3.4.24.28) a M4 member from Paenibacillus polymyxa.

FIG. 39: (SEQ ID NO:15) The amino acid sequence of Serralysin (EC 3.4.24.40) metallopeptidase family M10 member from Serratia liquefaciens.

FIG. 40: (SEQ ID NO:16) The amino acid sequence of Metalloprotease family M4 member from Aspergillus niger.

FIG. 41: (SEQ ID NO:17) The amino acid sequence of Metalloprotease family M4 member from Aspergillus terreus.

FIG. 42: (SEQ ID NO:18) The amino acid sequence of Metalloprotease MEP1 from Aspergillus kawachii IFO 4308.

FIG. 43: (SEQ ID NO:19) The amino acid sequence of Metalloprotease from Aspergillus oryzae (strain ATCC 42149/RIB 40).

FIG. 44: (SEQ ID NO:20) The amino acid sequence of Extracellular metalloprotease from Penicillium roqueforti.

FIG. 45: A alignment of NP7L (Seq1, SEQ ID NO:1 of FIG. 21) with NP14L (Seq2, FIG. 24) shows that these sequences have 38.4% identity (65.7% similar) using the server at embnet.vital-it.ch/software/LALIGN_form.html

FIG. 46: Increase of apparent viscosity (up-curves) in sour cream containing 5% (w/w) fat with and without NP7L addition

FIG. 47: Increase of apparent viscosity (up-curves) in sour cream containing 9% (w/w) fat with and without NP7L addition

FIG. 48: Predicted thickness in mouth of sour cream fermentations with and without NP7L

FIG. 49: Predicted stickiness in mouth of sour cream fermentations with and without NP7L

FIG. 50: Spidergraph of a sensory evaluation of an 18% (w/w) fat containing sour cream containing with and without addition of NP7L (***both enzymated samples are different from the non-enzymated (p<0.05)).

### DETAILED DESCRIPTION

In one aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product.

Preferably, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein the low pH sensitive peptidase is not chymosin or a chymosin-like enzyme.

Most preferably, the present invention provides a method of preparing a fermented milk product, the method comprising:

(a) treating a milk substrate with a low pH sensitive peptidase and a microorganism; and
(b) allowing the treated milk substrate to ferment to produce the fermented milk product; wherein said fermented milk product has improved viscosity.

In another aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has improved gel strength.

In a further aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has improved texture.

In a further aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has improved firmness of curd.

In a further aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has earlier onset of fermentation.

In a further aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has earlier onset of gelation.

In a further aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has earlier conclusion of fermentation.

In a further aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has reduced syneresis.

In a further aspect, the present invention provides a method of preparing a fermented milk product, the method comprising:

(a) treating a milk substrate with a low pH sensitive peptidase and a microorganism; and
(b) allowing the treated milk substrate to ferment to produce the fermented milk product;
wherein said fermented milk product has improved shelf life.

In a further aspect the present invention provides a fermented milk product prepared using a low pH sensitive peptidase and the use thereof, preferably wherein said low pH sensitive peptidase is a metallopeptidase, most preferably a metallopeptidase belonging to family M4.

In a further aspect the present invention provides a fermented milk product prepared using a low pH sensitive peptidase and the use thereof, preferably wherein said low pH sensitive peptidase is not chymosin or a chymosin-like enzyme.

In a preferred embodiment, low pH sensitive peptidase used in the present compositions and methods is exogenous. In a further preferred embodiment, the exogenous low pH sensitive peptidase is not naturally present and/or produced by the microorganism used to ferment the treated milk substrate.

### Fermented Milk Product

A “fermented milk product” is a product, preferably an edible product, which may also be referred to as a “food product” or “feed product”. The fermented milk product is the name given to the resulting product after step (b) of the method of the invention as described herein. In other words, it is a product produced by fermentation with a microorganism (as defined below).

The fermented milk product is a dairy product, preferably a yogurt, a frozen yogurt, a cheese (such as an acid curd cheese, a hard cheese, a semi-hard cheese, a cottage cheese), a butter, a buttermilk, quark, a sour cream, kefir, a fermented whey-based beverage, a koumiss, a milk beverage, a yoghurt drink, a fermented milk, a matured cream, a fromage frais, a milk, a fermented milk, a milk curd, a dairy product retentate, a processed cheese, a cottage cheese, a cream dessert, or infant milk.

In a preferred embodiment the fermented milk product is a yogurt, preferably a set yogurt or a stirred yogurt.

A stirred yogurt has been stirred after fermentation for at least 5 to 60 seconds. Most preferably, a stirred yogurt has been stirred after fermentation for at least 10 seconds. Most preferably, a stirred yogurt has been stirred after fermentation for at least 20 seconds. In a preferred embodiment, a stirred yogurt has been stirred after fermentation for at least 30 seconds. Stirring can be carried out with a hand mixer or electric mixer.

A set yogurt is not stirred after fermentation. After fermentation a set yogurt may be cooled and then stored. This is carried out without stirring.

The phrase “after fermentation” as used above means when fermentation is ended. In a preferred embodiment, “after fermentation” means after step (b) of the method of the invention. Step (b) (fermentation) preferably ends when a specific pH of the fermenting culture is reached. This pH is preferably between 3 and 6, most preferably between 4 and 5. In one embodiment the pH at which fermentation ends is 4.1. In a further embodiment the pH at which fermentation ends is 4.2. In another embodiment the pH at which fermentation ends is 4.3. In another embodiment the pH at which fermentation ends is 4.4. In another embodiment the pH at which fermentation ends is 4.5. In another embodiment the pH at which fermentation ends is 4.6. In another embodiment the pH at which fermentation ends is 4.7. In another embodiment the pH at which fermentation ends is 4.8. In a further embodiment the pH at which fermentation ends is 4.9.

Preferably fermentation ends at a pH which inactivates, or reduces the activity of, the low pH sensitive peptidase used in the invention. This is pH 4.6-4.8.

As used herein, the term “yoghurt” is an alternative spelling of “yogurt” with an identical meaning.

In a preferred embodiment, the fermented milk product is stirred during or following the fermentation step (b). Preferably stirring is carried out for at least 5 to 60 seconds, or more than 60 seconds. In one embodiment stirring is carried out for, at least 10 to 30 seconds. In a further embodiment stirring is carried out for at least 12 to 20 seconds. In a preferred embodiment stirring is carried out for at least 15 seconds. Stirring can be carried out with a hand mixer or electric mixer.

In one embodiment, after step (b) the fermented milk product is cooled, preferably immediately. This cooling may take place for example, using a water bath or heat exchanger. Preferably the fermented milk product is cooled to 20-30° C. Most preferably the fermented milk product is cooled to around 25° C. or to 25° C.

Alternatively, in one embodiment the fermented milk product is cooled to a lower temperature of 1-10° C., most preferably 4-6° C., after step (b) of the method of the invention. In one embodiment this cooling is carried out slowly by placing the fermented milk product in a cold room or refrigerator.

In a preferred embodiment the fermented milk product is cooled immediately after step (b) to 20-30° C., most preferably to around 25° C. or to 25° C. Then the fermented milk product is cooled for a second time, but this time to 1-10° C., most preferably 4-6° C. In one embodiment the fermented milk product is cooled for a second time to 3° C. In another embodiment the fermented milk product is cooled for a second time to 4° C. In a further embodiment the fermented milk product is cooled for a second time to 5° C.

In a preferred embodiment the second cooling is carried out slowly, for example over 10 to 48 hours. In one embodiment, cooling is carried out over 12 to 20 hours. In a preferred embodiment cooling is carried out over 15 to 20 hours. In a most preferred embodiment cooling is carried out over 10 hours or cooling is carried out over 15 hours. Most preferably this second cooling is carried out in a cold room or refrigerator.

In one embodiment, the stirring described above is carried out immediately after step (b) and before any cooling step. Stirring may also be carried out between two cooling steps.

The method of the invention may further include a storage step after step (b). This may be carried out after stirring and/or cooling (one or more times), preferably after both.

The fermented milk product produced by the methods of the current invention has one or more of the following features (further defined below):

(a) improved viscosity;
(b) improved gel strength;
(c) improved texture;
(d) improved firmness of curd;
(e) earlier onset of fermentation;
(f) earlier onset of gelation;
(g) earlier conclusion of fermentation;
(h) reduced syneresis;
(i) improved shelf-life;
(j) reduced stickiness; or
(k) any combination of (a) to (i).

In one embodiment, the fermented milk product produced by the methods of the current invention has improved viscosity.

In one embodiment, the fermented milk product produced by the methods of the current invention has improved gel strength.

In one embodiment, the fermented milk product produced by the methods of the current invention has improved texture.

In a further embodiment, the fermented milk product produced by the methods of the current invention has improved firmness of curd.

In one embodiment, the fermented milk product produced by the methods of the current invention has earlier onset of fermentation.

In a further embodiment, the fermented milk product produced by the methods of the current invention has earlier onset of gelation.

In a preferred embodiment, the fermented milk product produced by the methods of the current invention has earlier conclusion of fermentation.

In one embodiment, the fermented milk product produced by the methods of the current invention has reduced syneresis.

In a preferred embodiment, the fermented milk product produced by the methods of the current invention has improved shelf-life.

In a preferred embodiment, the fermented milk product produced by the methods of the current invention has reduced stickiness.

These features change the texture of the fermented milk product, preferably a yogurt, and also change the mouthfeel and taste.

The fermented milk product of the current invention also has a longer shelf life than a fermented milk product, most preferably a yogurt, which is not produced by the method of the invention and/or not produced using a low pH sensitive peptidase or by treating with a low pH sensitive peptidase.

As used herein, a “longer shelf-life” means that the fermented milk product can be stored for longer without a change in the texture, mouthfeel or taste, or an increase in syneresis of the product.

Storage is preferably carried out at a low temperature, preferably less than 10° C., most preferably 0-10° C. and more preferably 4-6° C.

In a preferred embodiment, the shelf-life is of the fermented milk product, most preferably a yogurt, produced by the method of the invention is increased by 5 to 28 days compared to a fermented milk product which is not produced by the method of the invention and/or not produced using a low pH sensitive peptidase or by treating with a low pH sensitive peptidase.

In a most preferred embodiment, the shelf-life is of the fermented milk product, produced by the method of the invention is increased by 5 to 28 days compared to a fermented milk product which is not produced by the method of the invention and/or not produced using a low pH sensitive peptidase or by treating with a low pH sensitive peptidase.

When two fermented milk products are compared, such as a product produced by the methods of the invention compared to one produced by other methods, they should be the same type of fermented milk product, for example a yogurt. This is illustrated in the examples.

### Milk Substrate

As used herein, the term “milk substrate” may encompass any milk or milk product. In particular the milk substrate may be of animal origin, in particular cow milk, ewe milk or goat milk. In one embodiment, the milk substrate may be a reduced fat milk, a 1% fat milk, 0.1% fat milk, a semi-skimmed milk or a skimmed milk (also known as a semi-skim milk and a skim milk respectively). The milk substrate may also be a blended milk.

A milk substrate is the starting material to which the method of the invention as described herein is applied.

An “inoculated milk substrate” as used herein means a milk substrate with lactic acid bacteria (LAB) added to it.

The milk substrate may be standardised or homogenised. For example, the milk substrate may be standardised at 1 to 10% or more protein weight to volume (w/v). In one embodiment the milk substrate may be standardised at 3-7% protein w/v. In a preferred embodiment the milk substrate may be standardised at or about 3.5% protein w/v. In another embodiment the milk substrate may be standardised at or about 3.6% protein w/v. In a most preferred embodiment the milk substrate may be standardised at about 4% or at 4% protein w/v.

The milk substrate may be standardised at 0 to 5% or more fat w/v. In one embodiment the milk substrate may be standardised at 0-1% fat w/v. In a preferred embodiment the milk substrate may be standardised at about 0.1% or at 0.1% fat w/v. In another embodiment the milk substrate may be standardised at about 0.025% to 0.05% fat w/v. In a further embodiment the milk substrate may be standardised at about 0.025% to 0.05% fat w/v. In a further embodiment the milk substrate may be standardised at about 1% to 5% fat w/v. In a preferred embodiment the milk substrate may be standardised at about 2% to 4% fate w/v. In a further embodiment the milk substrate may be standardised at about 3% fat w/v.

The milk substrate may be standardised for both fat and protein content. In a preferred embodiment, the milk substrate may be standardised at 3-7% protein and 0-1% fat v/w. In a most preferred embodiment the milk substrate may be standardised at or about 3.0 to 5.0% protein w/v and 0 to 10% fat v/w, most preferably 4.0% protein w/v and 0.1% fat w/v.

The milk substrate may be concentrated, condensed, heat treated, evaporated or filtered. It may also be dried or produced from a dried milk or a dried milk powder or other dried dairy product. It may be UHT milk. It may be rehydrated.

The milk substrate is preferably pasteurised and/or pre-pasteurised. Pasteurisation involves heating the milk substrate to at least 72° C. for at least 15 seconds, preferably 25 seconds or more. In one embodiment pasteurisation is carried out at least 73° C. for at least 15 seconds. In one embodiment pasteurisation is carried out at least 75° C. for at least 15 seconds. In a further embodiment pasteurisation is carried out at least 85° C. for at least 15 seconds. In a further embodiment pasteurisation is carried out at least 90° C. for at least 15 seconds. In another embodiment pasteurisation is carried out at least 95° C. for at least 15 seconds.

Pasteurisation may be carried out for at least 30 seconds. In one embodiment, pasteurisation may be carried out for at least 1 minute. In a further embodiment, pasteurisation may be carried out for at least 2-15 minutes. In another embodiment, pasteurisation may be carried out for at least 3-10 minutes. In a further embodiment, pasteurisation may be carried out for at least 15 minutes or more. Pasteurisation may take place in an autoclave.

In a most preferred embodiment pasteurisation is carried out at least 95° C. for 4-6 minutes. In one embodiment, both pre-pasteurisation and pasteurisation are carried out. Pre-pasteurisation is carried out on the raw milk before standardisation. Preferably pre-pasteurisation is carried out at 72-80° C., most preferably 72-75° C., most preferably 72° C. In one embodiment pre-pasteurisation is carried out for 15-25 seconds, most preferably 15 seconds.

In one aspect of the invention, the milk substrate is pasteurised after standardisation. Preferably this is carried out at the temperatures and for the times described above. In a preferred embodiment pasteurisation after standardisation is carried out at around 90° C. for around 10 minutes, preferably at 90° C. for 10 minutes.

Pasteurisation as described above may also be carried out in the absence of standardisation.

In one aspect the milk substrate has a pH (before fermentation) of 6-8, most preferably of at or around pH 6-7 and in some embodiments of at or around pH6.7-6.8.

The milk substrate is treated with a low pH sensitive peptidase. As used herein, the terms “treating” and “treated” may encompass, adding to, mixing with, contacting with, incubating with, stirring with, fermenting with, inoculating with, admixing and applying to. Therefore a method of “treating” a milk substrate with a low pH sensitive peptidase and a microorganism may refer to a method wherein a low pH sensitive peptidase and a microorganism are added to the milk substrate.

### Peptidase

As used herein, the term “peptidase” may be used interchangeably with “protease” and “proteinase”

As used herein, the term “peptidase” refers to any enzyme that catalyses the hydrolysis of peptides, peptones or their derivatives to amino acids and their oligomers and polymers.

As used herein, the terms “peptidase activity”, “protease activity”, “enzyme activity”, or simply “activity” in the context of peptidase enzymes, refer to the ability to hydrolyse peptide bonds.

In one more aspect, preferably the peptidases used herein preferably hydrolyse amino acid residues between the P1 and P1′ positions (using the P4-P3-P2-P1-↓-P1-P2-P3-P4′ nomenclature of Schechter and Berger 1967, wherein “↓” represents the bond hydrolysed). Most preferably the peptidases used herein hydrolyse peptides wherein there is a glycine residue at the P1 positions, as is the case for NP7L.

The substrate specificity of a peptidase is usually defined in terms of preferential cleavage of bonds between particular amino acids in a substrate. Typically, amino acid positions in a substrate peptide are defined relative to the location of the scissile bond (i.e. the position at which a peptidase cleaves):

NH₂— . . . P3-P2-P1*P1′-P2′-P3′ . . . —COOH

Illustrated using the hypothetical peptide above, the scissile bond is indicated by the asterisk (*) whilst amino acid residues are represented by the letter ‘P’, with the residues N-terminal to the scissile bond beginning at P1 and increasing in number when moving away from the scissile bond towards the N-terminus. Amino acid residues C-terminal to the scissile bond begin at P1′ and increase in number moving towards the C-terminal residue.

Peptidases can be also generally subdivided into two broad groups based on their substrate-specificity. The first group is that of the endoproteases, which are proteolytic peptidases capable of cleaving peptide bonds of amino acids located towards the middle of a substrate (i.e. non-terminal peptide bonds, not located towards the C or N-terminus of a peptide or protein substrate). Examples of endoproteases include trypsin, chymotrypsin and pepsin. In contrast, the second group of peptidases is the exopeptidases which cleave peptide bonds between amino acids located towards the C or N-terminus of the substrate (i.e. the terminal or penultimate peptide bond of a protein, wherein the process releases a single amino acid or dipeptide).

### Formulating and Packaging

The low pH sensitive peptidases used in the present invention, and/or starter cultures of the present invention, may be formulated into any suitable form.

Formulating may include pelleting, capsules, caplets, tableting, blending, coating, layering, formation into chewable or dissolvable tablets, formulating into dosage controlled packets, formulating into stick packs and powdering.

Formulating may also include the addition of other ingredients to the low pH sensitive peptidases used in the present invention, and/or starter cultures of the present invention. Suitable ingredients include for example food ingredients, sugars, carbohydrates, and dairy products.

In one embodiment formulating does not include the addition of any further microorganisms. In a preferred embodiment formulating does include the addition of any further microorganisms, for example additional strains of lactic acid bacteria.

The low pH sensitive peptidases used in the present invention, and/or starter cultures of the present invention of the present invention, may be packaged.

In one embodiment, packaging occurs after freezing and/or drying and/or mixing the low pH sensitive peptidases used in the present invention, and/or starter cultures of the present invention.

Suitably the packaging may be comprised of a vacuum pack, sachet, box, a blister pack, stick pack, or tin.

As used in the current invention, the low pH sensitive peptidases may be mixed a carrier, preferably an insoluble carrier. In a most preferred embodiment, the low pH sensitive peptidases may be mixed a carrier to obtain a slurry. The slurry may be dried to obtain a dried enzyme powder. This may be used as a starter culture or in a starter culture.

In a preferred embodiment this dried slurry powder contains with particles having a volume mean diameter greater than 10-30 pm, most preferably greater than 30 pm, and the content of insoluble carrier in the dried enzyme powder is at least 10% (w/w) and at the most 90% (w/w) based on the weight of the dried enzyme powder. The insoluble carrier is preferably selected from the group consisting of polyvinylpolypyrrolidone (PVPP), microcrystalline cellulose, and wheat starch, maltodextrins, preferably microcrystalline cellulose, and it may contain a disintegrant. These have been described in WO/2014/177644A1, Example 1-13.

The methods of the current invention may be carried out using a kit. Preferably such a kit comprises a low pH sensitive peptidase and a microorganism, which may be in the form of a starter culture and/or formulated and/or packaged as described above.

### Metalloprotease

The term “metalloprotease” as used herein refers to an enzyme having protease activity, wherein the catalytic mechanism of the enzyme involves a metal, typically having a metal ion in the active site. The low pH sensitive peptidase used in the invention may in a preferred embodiment be a metalloprotease.

The metal ion or ions of a metalloprotease may be any metal ion. Most preferably the metalloprotease as used herein contains metal ion or ions which are zinc, calcium or a combination of zinc and calcium.

Treatment with chelating agents removes the metal ion and inactivates metalloproteases. For example, EDTA is a metal chelator that removes essential zinc from a metalloprotease and therefore inactivates the enzyme.

Preferably the metalloprotease as used herein has a divalent ion, or two divalent ions, or more than two divalent ions at the active site.

Preferably the metalloprotease as used herein has a zinc ion in the active site, most preferably Zn²⁺. In some preferable metalloproteases there may be one zinc ion, in others there may be two or more zinc ions.

Preferably a metalloprotease comprises a His-Glu-Xaa-Xaa-His motif (where “Xaa” is any amino acid) which forms the metal ion binding site or part thereof.

In a preferred embodiment, wherein the metalloprotease is a member of the GluZincin superfamily, a zinc ion is bound by the amino acid motif His-Glu-Xaa-Xaa-His plus an additional glutamate. Preferably it contains 1 zinc ion and 2 calcium ions.

Most preferably the metalloprotease is from family M4, or the GluZincin superfamily.

The M4 enzyme family is characterised in that all enzymes in this family bind a single, catalytic zinc ion. As in many other families of metalloproteases, there is an His-Glu-Xaa-Xaa-His motif. The M4 family is further defined in Biochem. J. 290:205-218 (1993).

Preferably, the metalloprotease used in the present invention adopts a 3D structure similar to protein databank structures 1BQB (Staphylococcus aureus metalloprotease), 1 EZM (Pseudomonas aeruginosa metalloprotease) and 1NPC (Bacillus cereus metalloprotease). In a preferred embodiment, the metalloprotease has a cannibalistic autolysis site. This means that the metalloprotease may cause lysis of itself.

As used herein, the term “metalloprotease” may be used interchangeably with “metallopeptidase”, “metalloproteinase” and “neutralaprotease”.

### Low pH Sensitive

As used herein, the term “low pH sensitive” refers to a peptidase whose pH optimum is the same as or close to the pH of fresh milk (pH6.5-6.7) and whose activity is at least 2 times lower at pH 4.6-4.8 compared to pH6.5-6.7.

In a preferred embodiment, the low pH sensitive peptidase used in the present invention has an activity at least 10 times lower at pH 4.6-4.8 compared to pH6.5-6.7, and most preferably at least 15 times lower.

In a preferred embodiment, during fermentation the production of organic acids (e.g. lactic acid) lowers the pH and deactivates the low pH sensitive peptidases during the methods of the invention.

Preferably the low pH sensitive peptidase is irreversibly inactivated by low pH of 4.6-4.8. In a preferred embodiment, the low pH that reduces or inactivates the peptidases used in the invention is caused by fermentation. Most preferably this low pH is caused by microbial fermentation of sugars to organic acids, such as the fermentation of lactose to lactic acid. Most preferably the inactivation is permanent and the resulting fermented milk product therefore contains little, no, or only trace amounts of active peptidase. Preferably proteolytic activity is reduced, most preferably stopped, by the end of step (b) of the methods of the invention, or before or during storage

In a preferred embodiment, proteolytic activity ceases before or during storage, and the texture, viscosity and taste changes seen when other peptidases are used do not occur. For example, the changes seen when the cysteine protease papain from Worthington Biochemical Corporation (worthington-biochem.com/PAP/default.html) is used (Hoover et al (1947)), and serine protease Proteinase K from Tritiachium album from Roche Life Science (technical-support.roche.com/product.aspx?productId=2874) (Ebeling et al (1974) and Petrotchenko et al (2012)) and the aspartic protease Protex 15L (fda.gov/ucm/groups/fdagov-public/@fdagov-foods-gen/documents/document/ucm269518.pdf) (Nascimento et al (2008), Clarkson et al (2012)).

The reduction in activity at low pH for low pH sensitive peptidases is preferably caused by the disassociation of the metal ions. These metal ions are essential to the function of the enzyme, as described above.

The term “reduced activity” as used herein in the context of peptidases means a reduction in protease activity (also known as “peptidase activity”, “enzyme activity”, “endopeptidase activity” or “exopeptidase activity”) of 2 times or more units of peptidase activity compared to the units of peptidase activity at the activity maximum of pH6.5-6.7. In a preferred embodiment, “reduced activity” refers to activity of less than 50% that at the activity maximum of pH6.5-6.7.

The term “inactivates” as used herein in the context of peptidases means a reduction in protease activity of 2 times or more units of peptidase activity compared to the units of peptidase activity at the activity maximum of pH6.5-6.7. In a preferred embodiment, “inactivated” refers to activity of less than 90% that at the activity maximum of pH6.5-6.7.

One unit of endopeptidase activity was defined as the absorbance increase per min at 450 nm caused by 1 ug (microgram) NP7L active protein as described in Example 1 (Omondi et al (2001)).

In one embodiment the low pH sensitive peptidase is a thermostable peptidase. As used herein, the term “thermostable” means the enzyme has protease activity at temperatures of greater than 30° C., preferably 30° C.-60° C.

In one embodiment of the present invention, the low pH sensitive peptidase belongs to Enzyme Commission (E.C.) No. 3.4.17, 3.4.21 or 3.4.24.

In a further embodiment, the low pH sensitive peptidase is a thermolysin, an NprE molecule, proteolysin, aureolysin, Gentlyase or Dispase, or a peptidase having a high percentage identity to such an enzyme.

The low pH sensitive peptidase used in the present invention is not chymosin or chymosin-like (that is, does not have chymosin-like activity and does not specifically cleave the Met105-Phe106 bond), and does not belong to E.C. No. 3.4.23.4. The low pH sensitive peptidase used in the present invention preferably does not cleave the Met105-Phe106 bond, and most preferably does not cleave strictly the Met105-Phe106 bond only.

In one method of the present invention, the peptidase used consists of or comprises a mature protein excluding any signal sequence. In a further embodiment, the peptidase consists of or comprises a full length protein including a signal sequence.

The low pH sensitive peptidase is preferably of non-mammalian origin, and most preferably of non-animal origin. In a preferred embodiment, the low pH sensitive peptidase is a bacterial peptidase, a fungal peptidase, an archaeal peptidase or an artificial peptidase. In a most preferred embodiment the low pH sensitive peptidase is a bacterial metalloprotease, a fungal metalloprotease, an archaeal metalloprotease or an artificial metalloprotease.

An artificial peptidase is an enzyme in which one or more amino acids have been mutated, substituted, deleted or otherwise altered so the amino acid sequence of the enzyme differs from the wild-type, wherein the wild-type is obtainable from a living organism. An artificial peptidase may also be referred to as a variant peptidase.

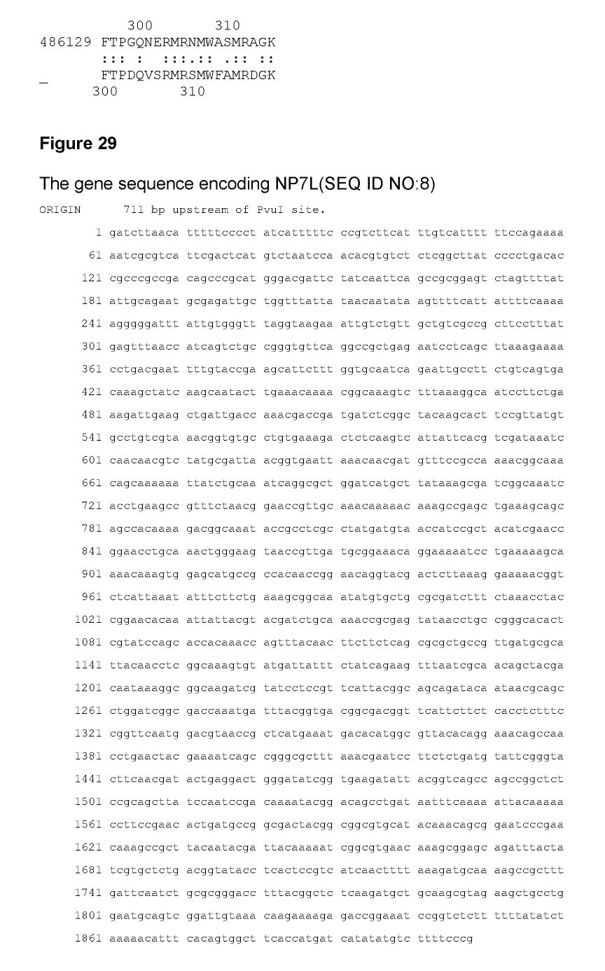

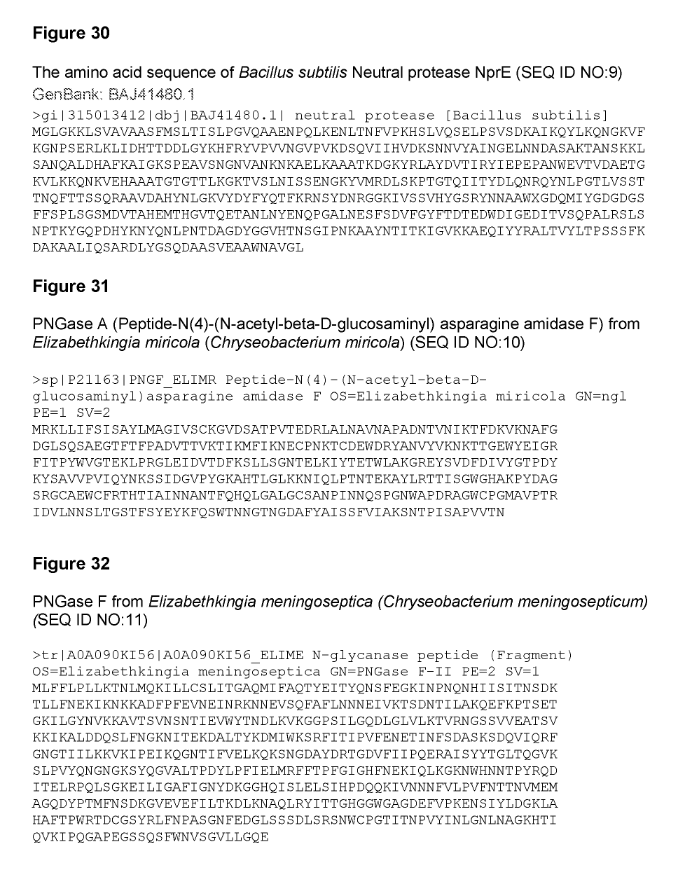

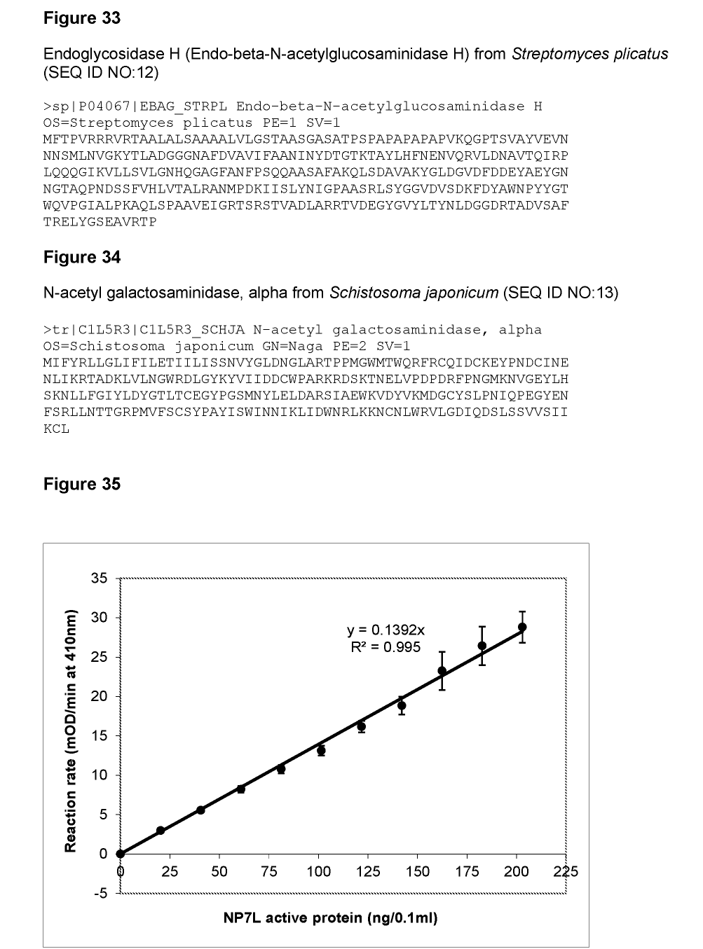

Peptidases of bacterial origin as used herein are preferably obtained or obtainable from Bacillus species, most preferably Bacillus amyloliquefaciens or Bacillus pumilus. Most preferably the low pH sensitive peptidase is, or has a high percentage identity to, NP7L, also known as NprE, Protex 7L, FoodPro PNL, Bacillolysin or Neutrase. Such a peptidase is shown as SEQ ID NO:1 (FIG. 21), and encoded by the nucleotide sequence of SEQ ID NO:8 (FIG. 29). NP7L is a metalloprotease.

Peptidases of bacterial origin as used herein may also be, or have a high percentage identity to, NP14L (SEQ ID NO:4, FIG. 24) also known as Thermolysin and Protex 14L. NP14L is also a metalloprotease.

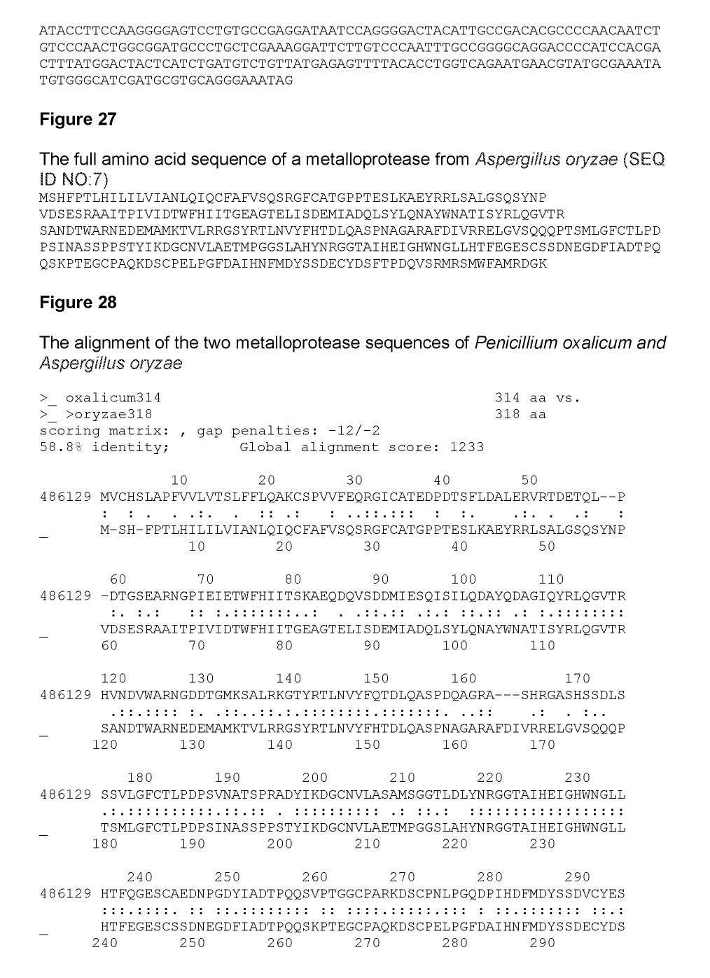

Peptidases of fungal origin as used herein are preferably obtained or obtainable from Penicillium (see for example SEQ ID NO:5, FIG. 25) Aspergillus (see for example SEQ ID NO:7, FIG. 27) Photorhabdus or Trichoderma species.

Peptidases of archaeal origin as used herein are preferably from Sulfolobus, most preferably Sulfolobus solfataricus

In one embodiment the low pH sensitive peptidase as used herein comprises a polypeptide having the amino acid sequence of SEQ ID NO:1 or a polypeptide having at least 70%, such as at least 75%, such as at least 80%, such as at least 85%, such as at least 90%, such as at least 95%, such as at least 97%, such as at least 98%, such as at least 99%, sequence identity thereto, or a functional variant thereof.

In one embodiment the low pH sensitive peptidase as used herein comprises a polypeptide having the amino acid sequence of SEQ ID NO:1, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:1, or a polypeptide having one or several amino acid deletions, substitutions and/or additions, or a functional variant thereof. For example, such a polypeptide may have 1, 2, 3, 4, 5, 6, 7, 8, 9, 10, 15, 20 or more amino acid deletions, substitutions and/or additions.

In one embodiment the low pH sensitive peptidase as used herein comprises a polypeptide having the amino acid sequence of SEQ ID NO:2 or a polypeptide having at least 70%, such as at least 75%, such as at least 80%, such as at least 85%, such as at least 90%, such as at least 95%, such as at least 97%, such as at least 98%, such as at least 99%, sequence identity thereto, or a functional variant thereof.

In one embodiment the low pH sensitive peptidase as used herein comprises a polypeptide having the amino acid sequence of SEQ ID NO:2, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:2, or a polypeptide having one or several amino acid deletions, substitutions and/or additions, or a functional variant thereof. For example, such a polypeptide may have 1, 2, 3, 4, 5, 6, 7, 8, 9, 10, 15, 20 or more amino acid deletions, substitutions and/or additions.

In one embodiment the low pH sensitive peptidase as used herein comprises a polypeptide having the amino acid sequence of SEQ ID NO:3 or a polypeptide having at least 70%, such as at least 75%, such as at least 80%, such as at least 85%, such as at least 90%, such as at least 95%, such as at least 97%, such as at least 98%, such as at least 99%, sequence identity thereto, or a functional variant thereof.

In one embodiment the low pH sensitive peptidase as used herein comprises a polypeptide having the amino acid sequence of SEQ ID NO:3, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:3, or a polypeptide having One or several amino acid deletions, substitutions and/or additions, or a functional variant thereof. For example, such a polypeptide may have 1, 2, 3, 4, 5, 6, 7, 8, 9, 10, 15, 20 or more amino acid deletions, substitutions and/or additions.

In one embodiment the low pH sensitive peptidase as used herein comprises a polypeptide having the amino acid sequence of SEQ ID NO:4 or a polypeptide having at least 70%, such as at least 75%, such as at least 80%, such as at least 85%, such as at least 90%, such as at least 95%, such as at least 97%, such as at least 98%, such as at least 99%, sequence identity thereto, or a functional variant thereof.

In one embodiment the low pH sensitive peptidase as used herein comprises a polypeptide having the amino acid sequence of SEQ ID NO:4, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:4, or a polypeptide having one or several amino acid deletions, substitutions and/or additions, or a functional variant thereof. For example, such a polypeptide may have 1, 2, 3, 4, 5, 6, 7, 8, 9, 10, 15, 20 or more amino acid deletions, substitutions and/or additions.

In one embodiment the low pH sensitive peptidase as used herein comprises a polypeptide having the amino acid sequence of SEQ ID NO:5 or a polypeptide having at least 70%, such as at least 75%, such as at least 80%, such as at least 85%, such as at least 90%, such as at least 95%, such as at least 97%, such as at least 98%, such as at least 99%, sequence identity thereto, or a functional variant thereof.

In one embodiment the low pH sensitive peptidase as used herein comprises a polypeptide having the amino acid sequence of SEQ ID NO:5, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:5, or a polypeptide having one or several amino acid deletions, substitutions and/or additions, or a functional variant thereof. For example, such a polypeptide may have 1, 2, 3, 4, 5, 6, 7, 8, 9, 10, 15, 20 or more amino acid deletions, substitutions and/or additions.

In one embodiment the low pH sensitive peptidase as used herein comprises a polypeptide having the amino acid sequence of SEQ ID NO:7 or a polypeptide having at least 70%, such as at least 75%, such as at least 80%, such as at least 85%, such as at least 90%, such as at least 95%, such as at least 97%, such as at least 98%, such as at least 99%, sequence identity thereto, or a functional variant thereof.

In one embodiment the low pH sensitive peptidase as used herein comprises a polypeptide having the amino acid sequence of SEQ ID NO:7, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:7, or a polypeptide having One or several amino acid deletions, substitutions and/or additions, or a functional variant thereof. For example, such a polypeptide may have 1, 2, 3, 4, 5, 6, 7, 8, 9, 10, 15, 20 or more amino acid deletions, substitutions and/or additions.

In one embodiment the low pH sensitive peptidase as used herein comprises a polypeptide having the amino acid sequence of SEQ ID NO:9, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:14, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:15, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:16, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:17, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:18, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:19, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:20, or a polypeptide having at least 70%, 75%, 80%, 85%, 90%, 95%, 97%, 98%, 99% sequence identity thereto, or a functional variant thereof.

As used herein, a “functional variant” of a peptidase meant that the enzyme has peptidase activity despite changes such as substitutions, deletions, mutations, missing or additional domains and other modifications.

As used herein, a “functional variant” of a metalloprotease meant that the enzyme has metalloprotease activity despite changes such as substitutions, deletions, mutations, missing or additional domains and other modifications.

In one embodiment the low pH sensitive peptidase comprises a full length enzyme including a signal peptide (also known as a signal sequence). A signal sequences directs the secretion of the polypeptide through a particular prokaryotic or eukaryotic cell membrane. In one embodiment the low pH sensitive peptidase comprises a polypeptide having the amino acid sequence of SEQ ID NO:1, lacking a signal sequence. In one embodiment the low pH sensitive peptidase used in the current invention comprises a polypeptide having the amino acid sequence of SEQ ID NO:2, but lacking a signal sequence. In a further embodiment the low pH sensitive peptidase used in the current invention comprises a polypeptide having the amino acid sequence of SEQ ID NO:3, but lacking a signal sequence. In a further embodiment the low pH sensitive peptidase used in the current invention comprises a polypeptide having the amino acid sequence of SEQ ID NO:4, but lacking a signal sequence.

In a further embodiment the low pH sensitive peptidase used in the current invention comprises a polypeptide having the amino acid sequence of SEQ ID NO:5, but lacking a signal sequence. In a further embodiment the low pH sensitive peptidase used in the current invention comprises a polypeptide having the amino acid sequence of SEQ ID NO:7, but lacking a signal sequence. In a further embodiment the low pH sensitive peptidase used in the current invention comprises a polypeptide having the amino acid sequence of SEQ ID NO:9, but lacking a signal sequence.

In a further embodiment the low pH sensitive peptidase used in the current invention comprises a polypeptide having the amino acid sequence of SEQ ID NO:14, but lacking a signal sequence. In a further embodiment the low pH sensitive peptidase used in the current invention comprises a polypeptide having the amino acid sequence of SEQ ID NO:15, but lacking a signal sequence. In a further embodiment the low pH sensitive peptidase used in the current invention comprises a polypeptide having the amino acid sequence of SEQ ID NO:16, but lacking a signal sequence. In a further embodiment the low pH sensitive peptidase used in the current invention comprises a polypeptide having the amino acid sequence of SEQ ID NO:17, but lacking a signal sequence.

In a further embodiment the low pH sensitive peptidase used in the current invention comprises a polypeptide having the amino acid sequence of SEQ ID NO:18, but lacking a signal sequence. In a further embodiment the low pH sensitive peptidase used in the current invention comprises a polypeptide having the amino acid sequence of SEQ ID NO:19, but lacking a signal sequence. In a further embodiment the low pH sensitive peptidase used in the current invention comprises a polypeptide having the amino acid sequence of SEQ ID NO:20, but lacking a signal sequence.

In a further embodiment the low pH sensitive peptidase comprises an amino acid sequence having at least 70%, such as at least 75%, such as at least 80%, such as at least 85%, such as at least 90%, such as at least 95%, such as at least 97%, such as at least 98%, such as at least 99%, sequence identity to SEQ ID NOs: 1, 2, 3, 4, 7, 9 or 14-20 lacking a signal peptide, or a functional variant thereof. In a further embodiment the low pH sensitive peptidase comprises an amino acid sequence having at least 70%, 75%, 80%, 85%, 90%, 95%, 97%, 98%, 99% sequence identity to SEQ ID NOs: 1, 2, 3, 4, 7, 9, or 14-20 and also lacking a signal peptide, or a functional variant thereof.

In a further embodiment, the low pH sensitive peptidase consists of a polypeptide having the amino acid sequence of SEQ ID NO:1, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:2, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:3, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:4, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:5 or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:7, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:9, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:14, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:15, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:16, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:17, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:18, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:19, or a polypeptide having at least 70%, 75%, 80%, 85%, 90%, 95%, 97%, 98%, 99% sequence identity thereto.

In a further embodiment, the low pH sensitive peptidase consists of a polypeptide having the amino acid sequence of SEQ ID NO:20, or a polypeptide having at least 70%, 75%, 80%, 85%, 90%, 95%, 97%, 98%, 99% sequence identity thereto.

Peptidases, like all proteins, may be encoded by a nucleic acid having a nucleotide sequence. The low pH sensitive peptidases used in the current invention may be obtained from or obtainable from a nucleic acid, for example as demonstrated by SEQ ID NO:8 or a variation thereof, which encodes SEQ ID NO:1, or SEQ ID NO:6 or a variation thereof which encodes SEQ ID NO:5. Said nucleic acid may be expressed in a host cell. Said nucleic acid may be obtained or obtainable from a host cell.

### Dosage

Preferably the dose of the low pH sensitive peptidase is in the range of 0.1 μg to 1000 μg active enzyme protein per kilo milk substrate, more preferably it is in the range of 1 μg to 100 μg active enzyme protein/kg milk products, more preferably it is 5-15 μg active enzyme/kg milk substrate and even more preferably it is 10 ug active enzyme protein/kg milk substrate. In a most preferred embodiment the dose of the low pH sensitive peptidase is 0.1-1 μg active enzyme protein/kg milk substrate.

In a further embodiment, the method of the invention in one aspect uses a dose of 0.01-100 units of peptidase enzyme, as defined in Example 1, per 100 ml of inoculated milk substrate. One unit of peptidase activity is defined as the absorbance increase per minute at 450 nm caused by 1 μg of active peptidase, preferable NP7L active peptidase (Omondi et al (2001)).

In a preferred embodiment, the method of the invention in one aspect uses a dose of 0.01-30 units of peptidase enzyme. In a most preferred embodiment, the method of the invention in one aspect uses a dose of 00.1-10 units of peptidase enzyme. In a most preferred embodiment, the method of the invention uses a dose of 0.1-1 units of peptidase enzyme. Most preferably around or exactly 0.9 units of peptidase enzyme per 100 ml of inoculated milk substrate are used.

Alternatively the peptidase dose may be measured as an amount per kilo of milk substrate. For example In a preferred embodiment, the method of the invention uses a dose of up to 1-10000 μg dosed to 1 kilo milk substrate (i.e., the enzyme concentration is in the range of 1-10000 ppb, parts per billion). Most preferably the peptidase dose is at an amount of up to 1-100 ppb.

If the dose of enzyme is too low, it may not cause the desired effect, while overdose (>100 mg enzyme protein per kilogram milk substrate) may lead to over hydrolysis converting milk proteins as polymers to oligomers and even amino acid. Overdosing will may change the texture, gelation, decrease viscosity, firmness of yogurt products.

A milk substrate or fermented milk product which has been treated with a peptidase may also be referred to as “enzymated”.

### Fermentation

As used herein, the term “fermentation” as used herein refers to the conversion of carbohydrates (such as sugars) to alcohols and CO₂ or organic acids using microorganisms such as yeasts and bacteria or any combination thereof. Fermentation is usually carried out under anaerobic conditions.

A fermented product has been produced using fermentation.

In the case of the fermented milk products of the invention, preferably they result from a milk substrate inoculated with a lactic acid bacterium, or any microbes that have GRAS status and can acidify milk by fermenting milk carbohydrates. For example a thermophilic culture such as YO-Mix 465, 532, 860 or 414 or a mesophilic culture such as Choozit 220, Choozit 230 or Probat 505 These culture strains are commercially available from DuPont (E. I. duPont de Nemours and Company, Inc., Wilmington, Del., USA).

In one embodiment, the milk substrate is fermented at 35-55° C., preferably 40-50° C. This temperature range is preferable for a thermophilic microorganism or a thermophilic culture. Most preferably, the fermentation temperature for a thermophilic microorganism or a thermophilic culture is 41° C. In a preferred embodiment the fermentation temperature is 42° C. In one embodiment the fermentation temperature is 43° C. In another embodiment the fermentation temperature is 44° C. In one embodiment the fermentation temperature is 45° C.

In another embodiment, the milk substrate is fermented at 15-30° C., preferably 20-25° C. This temperature range is preferable for a mesophilic microorganism or a mesophilic culture. Most preferably, the fermentation temperature for a mesophilic microorganism or a mesophilic culture is 21° C. In a preferred embodiment the fermentation temperature is 22° C. In one embodiment the fermentation temperature is 23° C. In another embodiment the fermentation temperature is 24° C. In one embodiment the fermentation temperature is 25° C.

Examples for fermentation temperature include at 30, 37 and 43° C. Fermentation temperature may affect the properties of the resulting fermented milk product (see Examples).

Preferably fermentation is conducted in a water bath or heat exchanger. Most preferably fermentation is carried in a fermentation tank or a beaker. In particular fermentation is carried in a fermentation tank for stirred yogurt or in a beaker for set yogurt.

In a preferred embodiment, fermentation, which is step (b) of the method of the invention, is ended when a specific pH is reached. This pH is preferably a more acidic pH than the starting pH of the milk substrate, most preferably a pH between 3 and 6, more preferably between 4 and 5. In one embodiment the pH at which fermentation ends is 4.5-4.8.

In one embodiment the pH at which fermentation ends is 4.7. In one embodiment the pH at which fermentation ends is 4.7.

The most preferable pH at which fermentation ends is at or around 4.6.

Most preferably, fermentation ends when the reduction in pH reduces the activity of, or completely inactivates, the low pH sensitive peptidase.

In one embodiment, after fermentation (step (b)) the now fermented milk product is cooled, preferably immediately as described above (see section entitled “Fermented Milk Product”). This may be before or after stirring, or no stirring may occur depending on the preferred product. This cooling may take place for example, using a water bath. Cooling can take place in one or two steps as described above. Preferably the fermented milk product is cooled to 20-30° C. Most preferably the fermented milk product is cooled to around 25° C. or to 25° C. Alternatively, in one embodiment the fermented milk product is cooled to a lower temperature of 1-10° C., most preferably 4-6° C., after step (b) of the method of the invention. In one embodiment this cooling is carried out slowly by placing the fermented milk product in a cold room or refrigerator. Alternatively both of these cooling steps can be applied, one after the other (as described above).

Fermentation may be stopped by cooling, or by the pH which may inhibit or kill the microorganisms of the fermentation culture.

Cooling stops the fermentation process. The fermented milk product can be stored at preferably 4-6° C., as further described above.

### Microorganism

The methods as described herein use a microorganism. This is for fermentation purposes.

Preferably said microorganism is a lactic acid bacterium.

As used herein, the term “lactic acid bacteria” (LAB) refers to any bacteria which produce lactic acid as the end product of carbohydrate fermentation. In a particular embodiment, the LAB is selected from the group consisting of species Streptococcus, Lactococcus, Lactobacillus, Leuconostoc, Pseudoleuconostoc, Pediococcus, Propionibacteriu, Enterococcus, Brevibacterium, and Bifidobacterium or any combination thereof, and any strains thereof.

Examples of suitable microorganism strains include Lactococcus lactis subsp lactis, Lactococcus lactis subsp cremoris, Lactococcus lactis subsp. lactis biovar diacetylactis, Leuconostoc mesenteroides subsp cremoris, Lactococcus lactis subsp lactis, Lactococcus lactis subsp cremoris, Streptococcus thermophilus, and Lactobacillus delbrueckii subsp. bulgaricus

A fermenting or otherwise growing colony of microorganisms (particularly LAB) may be referred to as a “culture”.

In one aspect the LAB is a mesophilic culture. Preferably fermentation of such a LAB is carried out at 15-30° C., most preferably 20-25° C.

A mesophilic culture may be, for example, Probat 505, Choozit 220 or Choozit 230. These cultures are commercially available from DuPont.

In a further aspect, the LAB is a thermophilic culture. Preferably fermentation of such a LAB is carried out at 30-55° C., most preferably 37-43° C. and most preferably at 43° C.

A thermophilic culture may be YO-MIX 414, 532 and 860 for example. These cultures are commercially available from DuPont.

In particular, the lactic acid bacteria (LAB) may be used in a blended culture, in an inoculum or a starter culture.

### Starter Cultures

The lactic acid bacteria (LAB) may be used in a starter culture.

In a particular embodiment the starter culture of the invention comprises the LAB and a low pH sensitive peptidase as described above.

The starter culture of the invention may be frozen, dried (e.g. spray dried), freeze dried, liquid, solid, in the form of pellets or frozen pellets, or in a powder or dried powder. The starter culture may be formulated and/or packaged as described above.

The starter culture may also comprise more than one LAB strain.

In a particular embodiment, said LAB starter culture, has a concentration of LAB which is between 10⁷ to 10¹¹ CFU, and more preferably at least at least 10⁷, at least 10⁸, at least 10⁹, at least 10¹⁰ or at least 10¹¹ CFU/g of the starter culture.

The invention also provides the use of a starter culture as defined above.

The starter culture of the invention may preferably be used for producing a fermented milk product, in particular a fermented milk product of the invention. A fermented milk product of the invention may be obtained and is obtainable by adding a starter culture to a milk substrate and allowing the treated milk substrate to ferment.

### Glycosidases

The milk substrate may additionally be treated with one or more glycosidases. This treatment may occur at any point, including before step (a), or after step (b) of the method of the invention. One or more glycosidases may be added during fermentation. In one embodiment one or more glycosidases may be added during step (a) and/or during step (b) of the method of the invention. In one embodiment a glycosidase may be added between steps (a) and (b) of the method.

Glycosidases hydrolyse glycosidic bonds.

In one aspect of the invention, the glycosidase is an N-linked or an O-linked glycosidase

In a preferred embodiment the glycosidase is a PNGase F belonging to Enzyme Commission (E.C.) 3.5.1.52.

In another embodiment the glycosidase is an Endoglycosidase H belonging to E.C. 3.2.1.96.

In another embodiment the glycosidase is a PNGase A belonging to E.C. 3.5.1.52.

In another embodiment the glycosidase is a Neuraminidase (NaNase) belonging to E.C. 3.2.1.18.

Preferably the glycosidase is selected from SEQ ID NO. 10, a PNGase A ((Peptide-N(4)-(N-acetyl-beta-D-glucosaminyl) asparagine amidase, EC 3.5.1.52), SEQ ID NO:11, a PNGase F, SEQ ID NO:12, an Endoglycosidase H (Endo-beta-N-acetylglucosaminidase H, EC 3.2.1.96,) or SEQ ID NO:13, an N-acetyl galactosaminidase, or a glycosidase having at least 70%, such as at least 75%, such as at least 80%, such as at least 85%, such as at least 90%, such as at least 95%, such as at least 97%, such as at least 98%, such as at least 99%, sequence identity to any thereof.

Preferably the glycosidase comprises a polypeptide having an amino acid sequence of SEQ ID No. 10, SEQ ID NO:11, SEQ ID NO:12 or SEQ ID NO:13, or a glycosidase having at least 70%, 75%, 80%, 85%, 90%, 95%, 97, 98%, 99%, sequence identity to any thereof.

Preferably the glycosidase comprises a polypeptide having an amino acid sequence of SEQ ID No. 10, or a glycosidase having at least 70%, 75%, 80%, 85%, 90%, 95%, 97, 98%, 99%, sequence identity to any thereof.

Preferably the glycosidase comprises a polypeptide having an amino acid sequence of SEQ ID No. 11, or a glycosidase having at least 70%, 75%, 80%, 85%, 90%, 95%, 97, 98%, 99%, sequence identity to any thereof.

Preferably the glycosidase comprises a polypeptide having an amino acid sequence of SEQ ID No. 12, or a glycosidase having at least 70%, 75%, 80%, 85%, 90%, 95%, 97, 98%, 99%, sequence identity to any thereof.

Preferably the glycosidase comprises a polypeptide having an amino acid sequence of SEQ ID No. 13, or a glycosidase having at least 70%, 75%, 80%, 85%, 90%, 95%, 97, 98%, 99%, sequence identity to any thereof.

### Uses

The methods of the current invention produce a fermented milk product. The current invention encompasses the use of these fermented milk products. Said fermented milk products have unexpected properties as described below.

Fermented milk products of the current invention preferably have improved viscosity. Preferably said fermented milk products have improved gel strength. Preferably said fermented milk products have improved texture. In one embodiment said fermented milk products have improved firmness of curd. Preferably said fermented milk products have earlier onset of fermentation and/or earlier onset of gelation and/or earlier conclusion of fermentation. In a preferred embodiment said fermented milk products have reduced syneresis. In a most preferred embodiment said fermented milk products have improved shelf-life.

In one embodiment the fermented milk products of the current invention have one or more of the following features:

(a) improved viscosity;
(b) improved gel strength;
(c) improved texture;
(d) improved firmness of curd;
(e) earlier onset of fermentation;
(f) earlier onset of gelation;
(g) earlier conclusion of fermentation;
(h) reduced syneresis; and
(i) improved shelf-life.

In particular, the current invention includes the use of a low pH sensitive peptidase in the production of a fermented milk product as discussed above.

In particular, the current invention encompasses the use of a low pH sensitive peptidase in the production of a fermented milk product for:

(a) improving viscosity;
(b) improving gel strength;
(c) improving texture;
(d) improving firmness of curd;
(e) providing earlier onset of fermentation;
(f) providing earlier onset of gelation;
(g) providing earlier conclusion of fermentation;
(h) reducing syneresis;
(i) improving shelf life; or
(j) any combination of (a) to (i).

In particular the fermented milk products produced by the methods of the invention are comparable to the same type of fermented milk product which has been produced by other methods. For example a yogurt of the current invention may show any one or more of the features (a) to (i) listed above when compared to a different yogurt, preferably made under the same conditions using the same LAB culture but without using a low pH sensitive peptidase. This is illustrated in the examples.

In particular the fermented milk products produced by the methods of the invention have all of the features of (a)-(i) without also suffering from increased acidification or a change in taste or change in mouthfeel. In particular they do not suffer from an increase in bitterness.

In a preferred embodiment the fermented milk products produced by the methods of the invention have all of the features of (a)-(i) as described above, no matter the size (volume and/or mass) of the culture. This is demonstrated in the examples.

The above features (a)-(i), and in particular (a)-(d), allow a fermented milk product to be produced at a higher pH without affecting texture or mouthfeel, but at a lower acidity. This reduces the acidity, and in particular the acidic or tart taste, of the product.

### (a) Improved Viscosity

In one embodiment the fermented milk products produced by the methods of the current invention have improved viscosity.

Improved viscosity preferably means increased viscosity, also known as high viscosity. Most preferably the fermented milk products of the current invention have high viscosity in comparison to fermented milk products which have not been treated with a low pH sensitive peptidase and/or not been produced by the method of the invention.

Increased viscosity can be demonstrated by increased shear stress. This may be for example measured as the shear force per unit area, using the calculation T=F/A; wherein

T=the shear stress;
F=the force applied;
A=the cross-sectional area of material with area parallel to the applied force vector.

The shear stress of the yoghurt as exemplified herein was analysed using an Anton Paar, Physica MCR 302, rheometer configured with a system of disposable aluminium cups (C-CC27/D/AL), measuring cup holder (H-CC27/D) and a vane stirrer (ST22/4V/40). The yoghurt samples are deposited in the aluminium cups right after production and are left to rest for at least 24 hours before measurement. Flow curves are measured in controlled strain mode with results represented as stress as function of strain. During the measurement the Strain is logarithmically increased from 0.1 s⁻¹ to 350 s⁻¹ and subsequent decreased from 350 s⁻¹ to 0.1 s⁻¹ in 50 steps over a period of 8 minutes and 20 seconds. The samples are measured at 10° C. and left 3 min. to equilibrate in the rheometer before measurements are taken.

In a preferred embodiment, the increase in shear stress is at least 5%-30%. In one embodiment the increase in shear stress is at least 10-20%. In a preferred embodiment, the increase in shear stress is more than 30%.

Most preferably the increase in viscosity is demonstrated after storage of up to 28 days. In a preferred embodiment, increased viscosity is demonstrated after storage of up to 14 days, or most preferably 5-7 days. Most preferably increased viscosity is demonstrated after storage of 6 days.

In a preferred embodiment, increased shear stress is measurable as an increase at a shear rate of 200-400 [1/s], most preferably at or around an increase of 350 [1/s].

### (b) Improved Gel Strength

Improved gel strength preferably means increased gel strength, also known as high gel strength.

Most preferably the fermented milk products of the current invention have high gel strength in comparison to fermented milk products which have not been treated with a low pH sensitive peptidase and/or not been produced by the method of the invention.

In a preferred embodiment the increase in gel strength is at least 5-150%. In one embodiment the increase in gel strength is at least 10-50%. In one embodiment the increase in gel strength is at least 100% or most preferably 150% or more.

Most preferably the increase in gel strength is demonstrated after storage of up to 28 days. In a preferred embodiment, increased gel strength is demonstrated after storage of up to 14 days, or most preferably 5-7 days.

Gel strength can be indicated using storage modulus size or texture profile analysis. Storage modulus is a measure of the energy stored in a material in which a deformation (for example sinusoidal oscillatory shear) has been imposed. In other words storage modulus can be described as that proportion of the total rigidity of a material that is attributable to elastic deformation. Storage modulus is typically measured in Pascals (Pa).

### (c) Improved Texture

Improved texture occurs as a result of the other features of the fermented milk product. It makes the product more pleasant to consume (has improved mouthfeel). Improved texture can be demonstrated using a texture profile analyser.

Texture is the combination of the physical features of the fermented milk product, which may for example include viscosity, gel strength, firmness of curd, fermentation time, gelation and amount of syneresis, which contribute to the mouthfeel of the fermented milk product.

(d) improved firmness of curd

Improved firmness of curd preferably means increased firmness of curd.

Most preferably the fermented milk products of the current invention have increased curd firmness in comparison to fermented milk products which have not been treated with a low pH sensitive peptidase and/or not been produced by the method of the invention.

Curd firmness in particular is a feature of set products such as set style yogurts.

Curd firmness can be measured by the force needed to penetrate the fermented milk product. For example, a texture profile analyzer can be used to measure this force.

In a preferred embodiment the increase in curd firmness is at least 1-60%%. In one embodiment the increase in curd firmness is at least 2-50%. In a preferred embodiment the increase in curd firmness is at least 5-20%. In a further embodiment, the increase in curd firmness is at least 10-15%. In one embodiment, the increase in curd firmness is most preferably 60% or more.

Most preferably the increase in curd firmness is demonstrated after storage of up to 28 days. In a preferred embodiment, increased curd firmness is demonstrated after storage of up to 14 days, or most preferably 5-7 days.

### (e) Earlier Onset of Fermentation

Fermentation may begin more quickly for milk substrates (which will become fermented milk products) of the current invention compared to milk substrates which have not been treated with a low pH sensitive peptidase and/or not been produced by the method of the invention.

In a preferred embodiment, after the microorganism and low pH sensitive peptidase have been added to the culture and the appropriate temperature applied, fermentation begins at least 20-180 minutes earlier than for a control culture lacking a low pH sensitive peptidase. In one embodiment, fermentation begins at least 30 minutes earlier than for a control culture lacking a low pH sensitive peptidase. In another embodiment, fermentation begins at least 40 minutes earlier than for a control culture lacking a low pH sensitive peptidase. In another embodiment fermentation begins at least 60 minutes earlier than for a control culture lacking a low pH sensitive peptidase. T

The low pH sensitive peptidase used in the methods of the present inventions because it cleaves peptides at multiple positions. Chymosin is known to make only one single specific cut on kappa-casein (milk protein) between Met105 and Phe106. The products of chymosin digestion are two large peptides para-kappa-casein 1-105 and glycosylated casein macropeptide 106-169. These molecules are too large to be taken up and assimilated by the LAB, thus fermentation may be delayed and proceed slowly, compared to metgods of the current invention.

The peptides generated by the low pH sensitive peptidases of the current invention (may also provide a favourable osmotic balanced environment for the LAB, which encourages fermentation. Other methods may lead to osmotic shock after inoculation, which delays onset of fermentation.

### (f) Earlier Onset of Gelation

Gelation during fermentation may begin more quickly for fermented milk products of the current invention compared to fermented milk products which have not been treated with a low pH sensitive peptidase and/or not been produced by the method of the invention. In a preferred embodiment, gelation begins 20-180 minutes earlier during fermentation than a control.

In one embodiment, gelation begins at least 30 minutes earlier than for a control culture lacking a low pH sensitive peptidase. In another embodiment, gelation begins at least 40 minutes earlier than for a control culture lacking a low pH sensitive peptidase. In another embodiment gelation begins at least 60 minutes earlier than for a control culture lacking a low pH sensitive peptidase.

In a preferred embodiment the early onset of gelation results in a higher stiffness of the yogurt gel, particularly a set yogurt gel, after a shorter fermentation time (for example 20-180 minutes shorter than a control without a low pH sensitive peptidase). This reduces the fermentation time of the yogurt, and thus increases productivity.

### (q) Earlier Conclusion of Fermentation

As described above, fermentation is concluded when a specific pH is reached. Said pH may no longer support fermentation, for example it may inhibit or kill the microorganisms of the culture. Alternatively fermentation may be actively stopped when a specific pH is reached or stopped for any another reason which makes it desired to halt fermentation. This is usually achieved by cooling, as described above.

In a preferred embodiment, a fermented milk product of the invention reaches a pH where fermentation is terminated more quickly than fermented milk products not made using the method of the current invention, preferably not made using a low pH sensitive peptidase. In one embodiment fermentation is concluded 20-180 minutes earlier.

In one embodiment, fermentation concludes at least 30 minutes earlier than for a control culture lacking a low pH sensitive peptidase. In another embodiment, fermentation concludes at least 40 minutes earlier than for a control culture lacking a low pH sensitive peptidase. In another embodiment fermentation concludes at least 60 minutes earlier than for a control culture lacking a low pH sensitive peptidase.

In a preferred embodiment, fermentation (which is step (b) of the method of the invention) is ended when a specific pH is reached. This pH is preferably between 3 and 6, most preferably between 4 and 5.

In one embodiment the pH at which fermentation ends is 4.5-4.8.

In one embodiment the pH at which fermentation ends is 4.7. In one embodiment the pH at which fermentation ends is 4.7.

The most preferable pH at which fermentation ends is at or around 4.6.

Most preferably, fermentation ends when the reduction in pH reduces the activity of, or completely inactivates, the low pH sensitive peptidase.

(h) Syneresis (the Removal of Liquid from the Gel, which May Form a Curd)

Syneresis occurs when liquid separates from a gel. In dairy products this may form a curd. Syneresis may also cause an unpleasant mouthfeel, an unpleasant texture and distaste.

In a preferred embodiment, syneresis of the fermented milk product, most preferably a yogurt, produced by the method of the invention, is reduced over 5-28 days compared to a fermented milk product which is not produced by the method of the invention, and/or not produced using a low pH sensitive peptidase or by treating with a low pH sensitive peptidase. In a most preferred embodiment, syneresis of the fermented milk product is reduced over 5-28 days, most preferably over 5-21 days. In a preferred embodiment, syneresis of the fermented milk product is reduced over 5-10 days, most preferably over 5-7 days

The term “reduced syneresis” as used herein means a reduction in the volume of liquid separated from the gel of a fermented milk product of the invention, compared to an otherwise identical fermented milk product made without using a low pH sensitive peptidase.

### (i) Improved Shelf Life

An “improved shelf life” (or shelf-life) as used herein means a longer shelf life. This means that the fermented milk product can be stored for longer without a change in the texture, mouthfeel or taste, or an increase in syneresis of the product. In particular “improved shelf life” means that the fermented milk product can be stored for longer without an increase in bitterness or bitter taste of the fermented milk product. This is due to the low pH sensitive peptidase becoming less active or inactivated, which halts further hydrolysis of milk proteins. Storage is preferably carried out at a low temperature, preferably less than 10° C., most preferably 0-10° C. and more preferably 4-6° C. Alternatively storage may require freezing at 0° C. or lower. In one embodiment, to create a frozen product storage is carried out at 0 to −30° C. or lower. In a preferred embodiment, to create a frozen product storage is carried out at −18° C. or lower.

In a preferred embodiment, the shelf life is of the fermented milk product produced by the method of the invention, most preferably a yogurt, is increased by 5-28 days compared to a fermented milk product, which is not produced by the method of the invention and/or not produced using a low pH sensitive peptidase or by treating with a low pH sensitive peptidase.

In one embodiment shelf-life is increased by up to 21 days or up to 14 days. In a preferred embodiment shelf life is increased by 5-10 days, most preferably 5-7 days.

The maximum shelf life or total range of shelf life is the total time a fermented milk product can stored after step (b) of the method of the invention before consumption or spoilage.

### Amino Acid Sequences

The scope of the present invention also encompasses the use of enzymes having the specific properties as defined herein. Said enzymes have specific amino acid sequences of enzymes. As used herein, the term “amino acid sequence” is synonymous with the term “polypeptide” and/or the term “protein”. In some instances as used herein, the term “amino acid sequence” is synonymous with the term “peptide”. In some instances as used herein, the term “amino acid sequence” is synonymous with the term “enzyme”.

The amino acid sequence may be prepared/isolated from a suitable source, or it may be made synthetically or it may be prepared by use of recombinant DNA techniques.

The proteins used in the present invention may be used in conjunction with other proteins, particularly enzymes. Thus the present invention also covers the use of a combination of proteins wherein the combination comprises enzyme of the present invention and another enzyme, which may be another enzyme for use according to the present invention. This aspect is discussed in a later section.

Preferably the amino acid sequence when relating to and when encompassed by the per se scope of the present invention is not a native enzyme. In this regard, the term “native enzyme” as used herein means an entire enzyme that is in its native environment and when it has been expressed by its native nucleotide sequence.

### Sequence Identity or Sequence Homology

The present invention also encompasses the use of sequences having a degree of sequence identity or sequence homology with amino acid sequence(s) of a polypeptide having the specific properties defined herein or of any nucleotide sequence encoding such a polypeptide (hereinafter referred to as a “homologous sequence(s)”). As used herein, the term “homologue” means an entity having a certain homology with the subject amino acid sequences and the subject nucleotide sequences. As used herein, the term “homology” can be equated with “identity”.

The homologous amino acid sequence and/or nucleotide sequence should provide and/or encode a polypeptide which retains the functional activity and/or enhances the activity of the enzyme.

In the present context, a homologous sequence is taken to include an amino acid or a nucleotide sequence which may be at least 75, 85 or 90% identical, preferably at least 95 or 98% identical to the subject sequence. Typically, the homologues will comprise the same active sites etc. as the subject amino acid sequence for instance. Although homology can also be considered in terms of similarity (i.e. amino acid residues having similar chemical properties/functions), in the context of the present invention it is preferred to express homology in terms of sequence identity.

In one embodiment, a homologous sequence is taken to include an amino acid sequence or nucleotide sequence which has one or several additions, deletions and/or substitutions compared with the subject sequence.

In one embodiment the present invention relates to the use of a protein whose amino acid sequence is represented herein or a protein derived from this (parent) protein by substitution, deletion or addition of one or several amino acids, such as 2, 3, 4, 5, 6, 7, 8, 9 amino acids, or more amino acids, such as 10 or more than 10 amino acids in the amino acid sequence of the parent protein and having the activity of the parent protein.

Suitably, the degree of identity with regard to an amino acid sequence is determined over at least 20 contiguous amino acids, preferably over at least 30 contiguous amino acids, preferably over at least 40 contiguous amino acids, preferably over at least 50 contiguous amino acids, preferably over at least 60 contiguous amino acids, preferably over at least 100 contiguous amino acids, preferably over at least 200 contiguous amino acids.

In one embodiment the present invention relates to the use of a nucleic acid sequence (or gene) encoding a protein whose amino acid sequence is represented herein or encoding a protein derived from this (parent) protein by substitution, deletion or addition of one or several amino acids, such as 2, 3, 4, 5, 6, 7, 8, 9 amino acids, or more amino acids, such as 10 or more than 10 amino acids in the amino acid sequence of the parent protein and having the activity of the parent protein.

In the present context, a homologous sequence is taken to include a nucleotide sequence which may be at least 75, 85 or 90% identical, preferably at least 95 or 98% identical to a nucleotide sequence encoding a polypeptide of the present invention (the subject sequence). Typically, the homologues will comprise the same sequences that code for the active sites etc. as the subject sequence. Although homology can also be considered in terms of similarity (i.e. amino acid residues having similar chemical properties/functions), in the context of the present invention it is preferred to express homology in terms of sequence identity.

Homology comparisons can be conducted by eye, or more usually, with the aid of readily available sequence comparison programs. These commercially available computer programs can calculate % homology between two or more sequences.

% homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons.

Calculation of maximum % homology or % identity therefore firstly requires the production of an optimal alignment, taking into consideration gap penalties. A suitable computer program for carrying out such an alignment is the Vector NTI (Invitrogen Corp.). Examples of software that can perform sequence comparisons include, but are not limited to, the BLAST package (see Ausubel et al 1999 Short Protocols in Molecular Biology, 4th Ed—Chapter 18), BLAST 2 (see FEMS Microbiol Lett 1999 174(2): 247-50; FEMS Microbiol Lett 1999 177(1): 187-8), FASTA (Altschul et al 1990 J. Mol. Biol. 403-410) and AlignX for example. At least BLAST, BLAST 2 and FASTA are available for offline and online searching (see Ausubel et al 1999, pages 7-58 to 7-60), such as for example in the GenomeQuest search tool (genomequest.com).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI package.

Alternatively, percentage homologies may be calculated using the multiple alignment feature in Vector NTI (Invitrogen Corp.), based on an algorithm, analogous to CLUSTAL (Higgins D G & Sharp P M (1988), Gene 73(1), 237-244).

Once the software has produced an optimal alignment, it is possible to calculate % homology, preferably % sequence identity. The software typically does this as part of the sequence comparison and generates a numerical result.

Should Gap Penalties be used when determining sequence identity, then preferably the following parameters are used for pairwise alignment:

| FOR BLAST | |
|---|---|
| GAP OPEN | 9 |
| GAP EXTENSION | 2 |

| FOR CLUSTAL | DNA | PROTEIN |
|---|---|---|
| Weight Matrix | IUB | Gonnet 250 |
| GAP OPENING | 15 | 10 |
| GAP EXTEND | 6.66 | 0.1 |

In one embodiment, CLUSTAL may be used with the gap penalty and gap extension set as defined above.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides.

Suitably, the degree of identity with regard to a nucleotide sequence is determined over at least 100 contiguous nucleotides, preferably over at least 200 contiguous nucleotides, preferably over at least 300 contiguous nucleotides, preferably over at least 400 contiguous nucleotides, preferably over at least 500 contiguous nucleotides, preferably over at least 600 contiguous nucleotides, preferably over at least 700 contiguous nucleotides, preferably over at least 800 contiguous nucleotides.

Suitably, the degree of identity with regard to a nucleotide sequence may be determined over the whole sequence.

Suitably, the degree of identity with regard to a protein (amino acid) sequence is determined over at least 100 contiguous amino acids, preferably over at least 200 contiguous amino acids, preferably over at least 300 contiguous amino acids.

Suitably, the degree of identity with regard to an amino acid or protein sequence may be determined over the whole sequence taught herein.

In the present context, the term “query sequence” means a homologous sequence or a foreign sequence, which is aligned with a subject sequence in order to see if it falls within the scope of the present invention. Accordingly, such query sequence can for example be a prior art sequence or a third party sequence.

In one preferred embodiment, the sequences are aligned by a global alignment program and the sequence identity is calculated by identifying the number of exact matches identified by the program divided by the length of the subject sequence.

In one embodiment, the degree of sequence identity between a query sequence and a subject sequence is determined by 1) aligning the two sequences by any suitable alignment program using the default scoring matrix and default gap penalty, 2) identifying the number of exact matches, where an exact match is where the alignment program has identified an identical amino acid or nucleotide in the two aligned sequences on a given position in the alignment and 3) dividing the number of exact matches with the length of the subject sequence.

In yet a further preferred embodiment, the global alignment program is selected from the group consisting of CLUSTAL and BLAST (preferably BLAST) and the sequence identity is calculated by identifying the number of exact matches identified by the program divided by the length of the subject sequence.

The sequences may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to the Table below. Amino acids in the same block in the second column and preferably in the same line in the third column may be substituted for each other:

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur i.e. like-for-like substitution such as basic for basic, acidic for acidic, polar for polar etc. Non-homologous substitution may also occur i.e. from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyriylalanine, thienylalanine, naphthylalanine and phenylglycine.

Replacements may also be made by synthetic amino acids (e.g. unnatural amino acids) include; alpha* and alpha-disubstituted* amino acids, N-alkyl amino acids*, lactic acid*, halide derivatives of natural amino acids such as trifluorotyrosine*, p-Cl-phenylalanine*, p-Br-phenylalanine*, p-I-phenylalanine*, L-allyl-glycine*, β-alanine*, L-α-amino butyric acid*, L-γ-amino butyric acid*, L-α-amino isobutyric acid*, L-ε-amino caproic acid^{#}, 7-amino heptanoic acid*, L-methionine sulfone^{#*}, L-norleucine*, L-norvaline*, p-nitro-L-phenylalanine*, L-hydroxyproline^{#}, L-thioproline*, methyl derivatives of phenylalanine (Phe) such as 4-methyl-Phe*, pentamethyl-Phe*, L-Phe (4-amino)^{#}, L-Tyr (methyl)*, L-Phe (4-isopropyl)*, L-Tic (1,2,3,4-tetrahydroisoquinoline-3-carboxyl acid)*, L-diaminopropionic acid # and L-Phe (4-benzyl)*. The notation * has been utilised for the purpose of the discussion above (relating to homologous or non-homologous substitution), to indicate the hydrophobic nature of the derivative whereas # has been utilised to indicate the hydrophilic nature of the derivative, #* indicates amphipathic characteristics.

Variant amino acid sequences may include suitable spacer groups that may be inserted between any two amino acid residues of the sequence including alkyl groups such as methyl, ethyl or propyl groups in addition to amino acid spacers such as glycine or β-alanine residues. A further form of variation, involves the presence of one or more amino acid residues in peptoid form, will be well understood by those skilled in the art. For the avoidance of doubt, “the peptoid form” is used to refer to variant amino acid residues wherein the α-carbon substituent group is on the residue's nitrogen atom rather than the α-carbon. Processes for preparing peptides in the peptoid form are known in the art, for example Simon R J et al., PNAS (1992) 89(20), 9367-9371 and Horwell D C, Trends Biotechnol. (1995) 13(4), 132-134.

The nucleotide sequences for use in the present invention may include within them synthetic or modified nucleotides. A number of different types of modification to oligonucleotides are known in the art. These include methylphosphonate and phosphorothioate backbones and/or the addition of acridine or polylysine chains at the 3′ and/or 5′ ends of the molecule. For the purposes of the present invention, it is to be understood that the nucleotide sequences described herein may be modified by any method available in the art. Such modifications may be carried out in order to enhance the in vivo activity or life span of nucleotide sequences of the present invention.

The present invention also encompasses the use of nucleotide sequences that are complementary to the sequences presented herein, or any derivative, fragment or derivative thereof. If the sequence is complementary to a fragment thereof then that sequence can be used as a probe to identify similar coding sequences in other organisms etc.

Polynucleotides which are not 100% homologous to the sequences for use in the present invention but fall within the scope of the invention can be obtained in a number of ways. Other variants of the sequences described herein may be obtained for example by probing DNA libraries made from a range of individuals, for example individuals from different populations. In addition, other homologues may be obtained and such homologues and fragments thereof in general will be capable of selectively hybridising to the sequences shown in the sequence listing herein. Such sequences may be obtained by probing cDNA libraries made from or genomic DNA libraries from other animal species, and probing such libraries with probes comprising all or part of any one of the sequences in the attached sequence listings under conditions of medium to high stringency. Similar considerations apply to obtaining species homologues and allelic variants of the polypeptide or nucleotide sequences of the invention.

Variants and strain/species homologues may also be obtained using degenerate PCR which will use primers designed to target sequences within the variants and homologues encoding conserved amino acid sequences within the sequences of the present invention. Conserved sequences can be predicted, for example, by aligning the amino acid sequences from several variants/homologues. Sequence alignments can be performed using computer software known in the art. For example the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterised sequences. This may be useful where for example silent codon sequence changes are required to optimise codon preferences for a particular host cell in which the polynucleotide sequences are being expressed. Other sequence changes may be desired in order to introduce restriction enzyme recognition sites, or to alter the property or function of the polypeptides encoded by the polynucleotides.

Polynucleotides (nucleotide sequences) for use in the invention may be used to produce a primer, e.g. a PCR primer, a primer for an alternative amplification reaction, a probe e.g. labelled with a revealing label by conventional means using radioactive or non-radioactive labels, or the polynucleotides may be cloned into vectors. Such primers, probes and other fragments will be at least 15, preferably at least 20, for example at least 25, 30 or 40 nucleotides in length, and are also encompassed by the term polynucleotides of the invention as used herein.

Polynucleotides such as DNA polynucleotides and probes for use according to the invention may be produced recombinantly, synthetically, or by any means available to those of skill in the art. They may also be cloned by standard techniques.

In general, primers will be produced by synthetic means, involving a stepwise manufacture of the desired nucleic acid sequence one nucleotide at a time. Techniques for accomplishing this using automated techniques are readily available in the art.

Longer polynucleotides will generally be produced using recombinant means, for example using a PCR (polymerase chain reaction) cloning techniques. The primers may be designed to contain suitable restriction enzyme recognition sites so that the amplified DNA can be cloned into a suitable cloning vector.

### Hybridisation

The present invention also encompasses the use of sequences that are complementary to the nucleic acid sequences for use in the present invention or sequences that are capable of hybridising either to the sequences for use in the present invention or to sequences that are complementary thereto.

The term “hybridisation” as used herein shall include “the process by which a strand of nucleic acid joins with a complementary strand through base pairing” as well as the process of amplification as carried out in polymerase chain reaction (PCR) technologies.

### EXAMPLES

One of the most important quality attributes for yogurt is its texture. These examples demonstrate the effect of metalloproteases NP7L (SEQ ID NO:1) and NP14L (SEQ ID NO:4) on texture, but are not intended to be limited to these low pH sensitive metalloproteases or to the specific fermented milk products tested. Standardised and pasteurised skim milk (4% protein, 0.1% fat) and different thermophilic and mesophilic cultures were used. The samples were analysed after 5, 14 and 28 days of storage at 4° C. It was shown that by adding the NP7L the viscosity and the stiffness of the curd in stirred and set style yogurt increased. Applying mesophilic cultures showed an increase of shear stress of about 60%, for thermophilic cultures between 10-20%. A higher viscosity and curd stiffness of about 30% was detected after applying thermophilic cultures, however at lower fermentation temperatures of 30 and 37° C. In addition, the storage modulus could be increased by about 100%, after the addition of NP7L. The positive effects were shown over shelf life (28 days) and for both yogurt types no increased syneresis formation was observed. Furthermore, the possibility to produce a milder (less acidic) stirred yogurt employing NP7L was demonstrated. A comparable viscosity for non-enzymated yogurt stopped at pH 4.6 and enzymated yogurt, which was stopped at pH 4.8, was obtained. In addition, these examples demonstrate that the onset of gel formation started earlier in the enzymated yogurt milk compared to the non-enzymated.

### Example 1a: Endopeptidase Activity Determination Employing the Azocasein-Assay and Assay of NP7L Using N-CBZ-Glycine p-Nitrophenyl Ester

The azocasein-assay was conducted as described by Iversen and Jorgensen (1995) with minor modifications. A casein conjugated to an azo dye is used as a substrate for proteolytic enzymes. Preferably the azocasein is Protazyme tablet from Megazyme and the procedure of Megazyme is used (megazyme.com). Degradation of casein liberates the dye which can then be analysed. A volume of 250 μl of 0.25% (w/v) Azocasein, dissolved in 20 mM MES buffer with a pH of 6.7, was added in to a 1.5 ml reaction tube. Subsequently, 50 μl of appropriately pre-diluted endopeptidase were added to the pre-incubated azocasein (wherein said pre-incubation is carried out at 40° C.) and incubated for 5 to 60 min at 40° C. (shaking 800 rpm in a thermomixer). The reaction was terminated by addition of 2 M TCA (50 μl) and the reaction tube was centrifuged at 15,000 rpm for 5 min. Following, 195 μl of the resulting supernatant were transferred into a microtiterplate and combined with 1 M NaOH (65 μl). The absorbance was measured in a MTP reader at 450 nm.

One unit of endopeptidase activity was defined as the absorbance increase per min at 450 nm caused by 1 μg NP7L active protein. This assay was used to determine the activity of the peptidases used in the invention. Alternative assays may also be used, for example the Neutral protease assay (as detailed in the Worthington Enzyme Manual—Worthington, K., et al (1993) and (2011). As of 5 Dec. 2014 (worthington-biochem.com/pap/default.html)).

For a more specific determination of the activity of NP7L in the absence of esterase and lipase activity, the reaction mixture contained 0.4 mM N-CBZ-glycine p-nitrophenyl ester (Sigma-Aldrich, cat no. C-7626) and NP7L (20.3 mg active protein/ml) in the range of 20 to 200 nanogram (ng) active protein in a reaction volume of 0.1 ml in 0.25 M Mops-NaOH (pH7.0) containing 5 mM CaCl₂ and 0.1% (w/v) Tween 80 in 96 MTP. The reaction was started after a pre-incubation at 30° C. for 5 min by adding the substrate, n=5. The reaction was followed at 410 nm every one min for 25 min. Initial velocity was expressed as mOD/min (FIG. 35). From FIG. 35 it can be seen that this method can assay samples having NP7L active protein in the range of 20 to 200 ng/0.1 ml (0.2-2 microgram/ml). This method is used in the current invention to determine enzymes that have a high preference of glycine residue at P1 including NP7L. For NP7L it can be seen from FIG. 35 that 100 ng active protein gave rise to a reaction rate of 30.27 mOD/min.

### Example 1b: Endopeptidase Activity Determination Including NP7L Determination Employing Chromogenic Substrate Z-Val-Gly-Arg-pNA at the pH of Yogurt (pH4.6) and the pH of Fresh Milk (pH6.7)

The reaction mixture contained 85 ul 0.1M acetate (pH4.6) or 50 mM glycine-50 mM acetate-50 mM Tris (4.6), or 0.1M Mes-NaOH (pH4.6), or 0.1M Mes-NaOH (pH6.7), 1 ul 500 mM CaCl2, 5 ul 10 mM chromogenic substrate Z-Val-Gly-Arg-pNA (BVGApNA) acetate salt (cat. no. L-1555, Bachem. com). The reaction was started by adding 10 μl 25 times diluted NP7L product (20.3 mg active enzyme protein/g product) diluted in 12 mM CaCl2. OD410 nm were followed at 30° C. every 1 min. For a control, 10 μl enzyme was replaced with 10 ul 12 mM CaCl2 (Levine et al., (2008)).

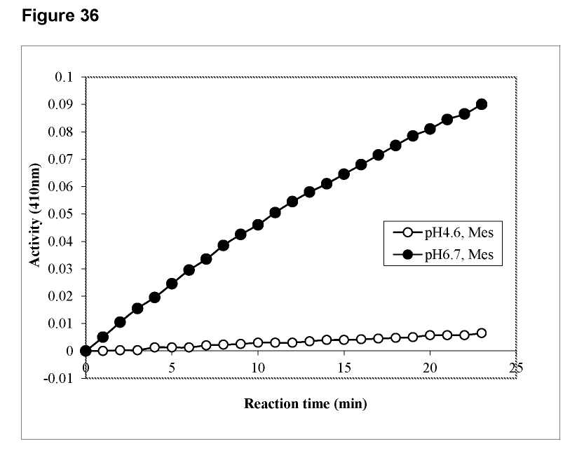

The results of this experiment show in FIG. 36 that under the assay conditions using acetate buffer or glycine-acetate-tris buffer or 0.1M Mes-NaOH having pH4.6, the same pH as yogurt, NP7L had low activity, whereas in Mes buffer at pH6.7 (the pH of fresh milk) it had considerably high activity as the linear increase at 410 nm as a result of the hydrolysis of the peptide BVGApNA. FIG. 36 shows that NP7L activity on BVGApNA at pH 4.6 and 6.7 in Mes-NaOH buffer. The slope ratio of pH 6.7 to pH 4.6 in the linear part of the reaction was 16 (FIG. 36). As an ideal yogurt enzyme it should be most active at the pH of the fresh milk (pH6.7) and most inactive when the pH reached the yogurt's pH of 4.6.

### Example 1c: Endopeptidase Activity Determination Including NP7L Determination Employing Fluorogenic Substrate Abz-AAFFAA-Anb

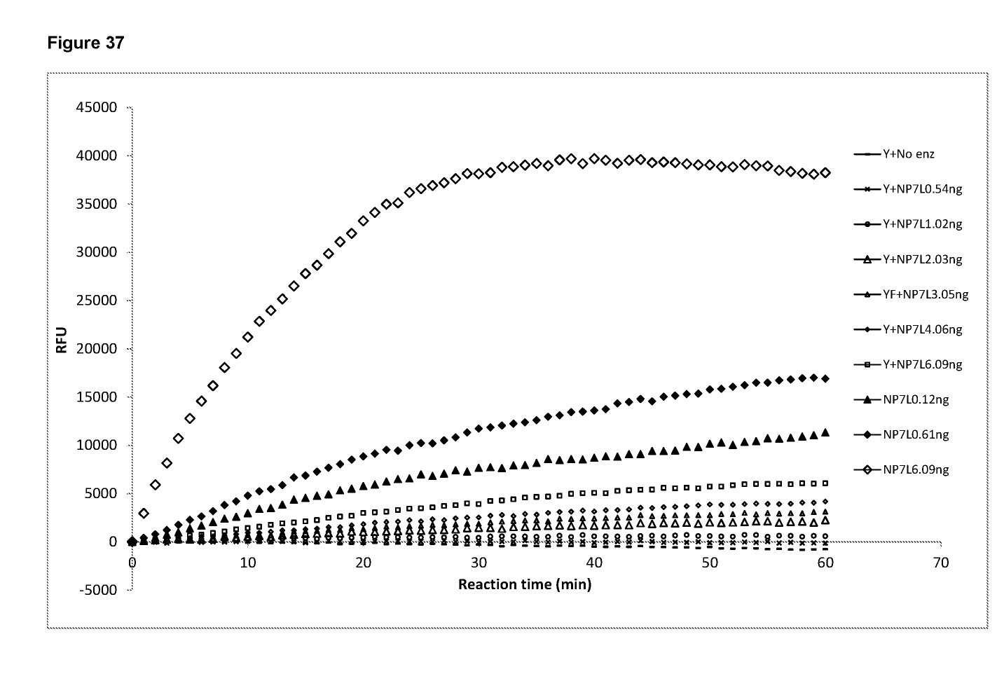

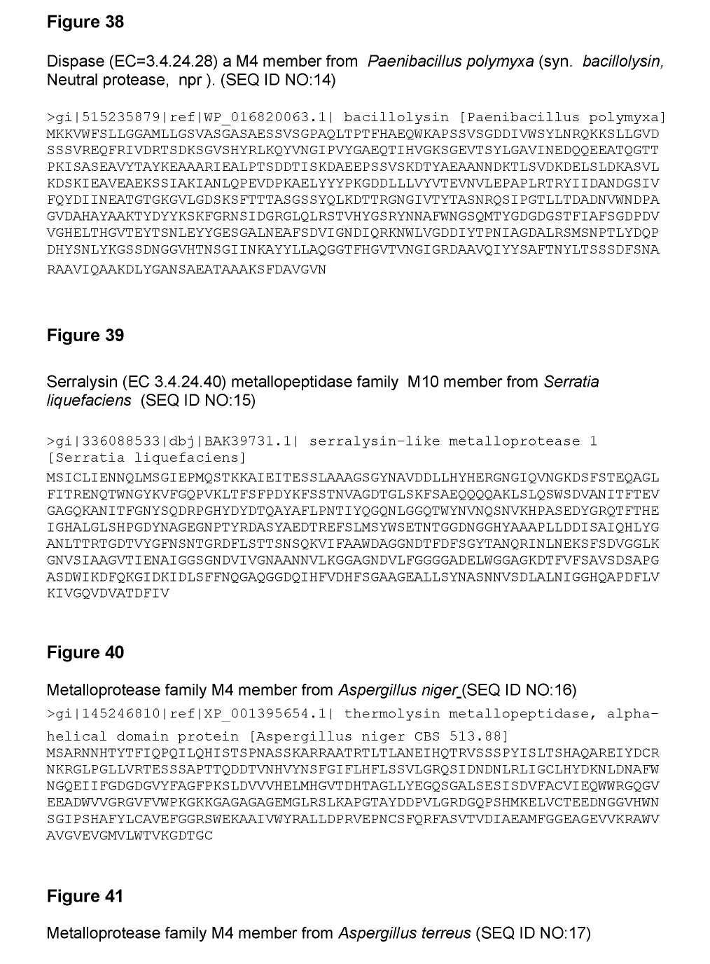

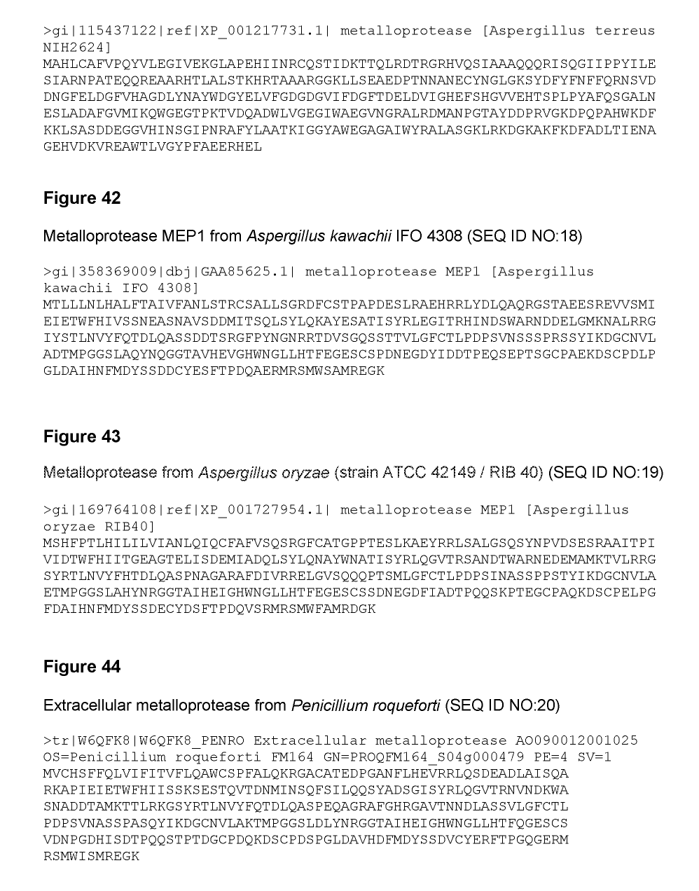

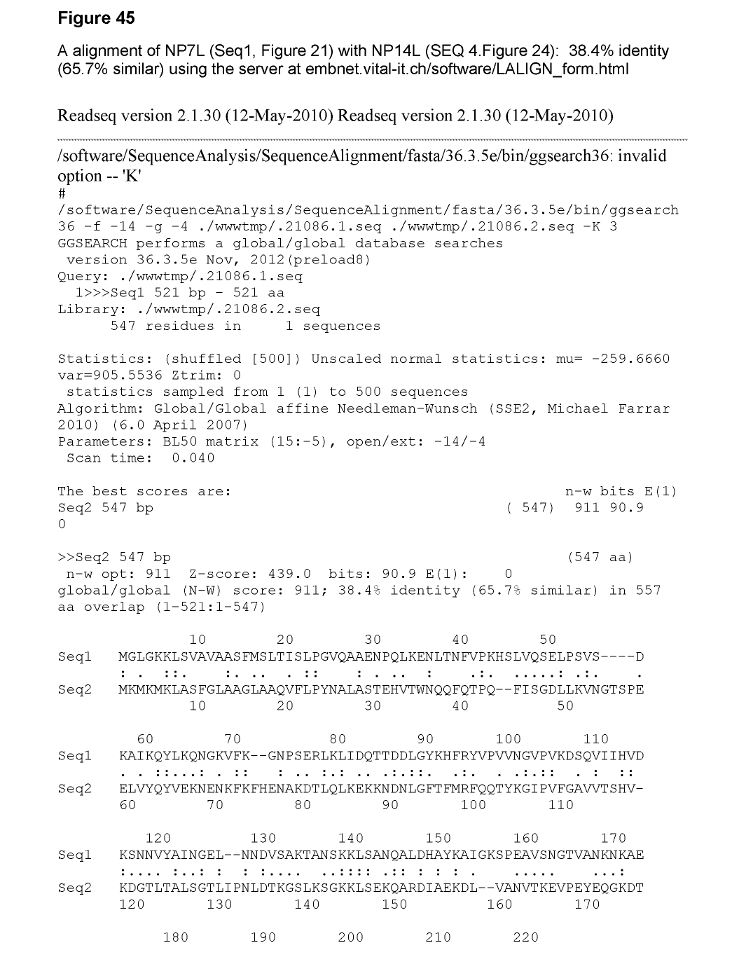

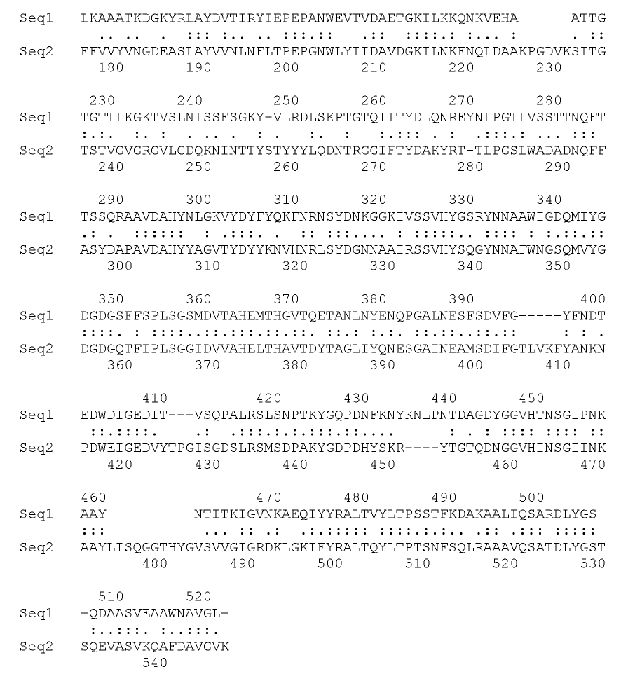

The reaction mixture contained 2.5 ul 10 mM Abz-AAFFAA-Anb fluorogenic substrate (Schafer-N, Copenhagen, Denmark), 50 ul 0.25 M Mops-NaOH (pH7.0) containing 5 mM CaCl₂ and 0.1% (w/v) Tween 80 or 50 ul yogurt 0.22 um filtrate in 96 MTP. The reaction was started after a pre-incubation at 40° C. for 5 min by adding the substrate, n=2. The reaction was followed as RFU (relative fluorescence unit) at the emission of 420 nm by excitation 320 nm every one min for 60 min using as SpectraMax M5 microplate reader from Molecular Devices Inc. (USA) (Filippova et al., (1996)). Each data point in FIG. 37 is the average 4 reading points from 2 yogurt samples. The maximum standard deviation value was 900 RFU. Initial velocity was expressed as RFU/min (FIG. 37).

Yogurt samples used in FIG. 37: Low fat bulk milk was standardized to 4% protein, pasteurized at 90° C. for 10 min, and stored over night at 5° C. The milk was inoculated with Yo-Mix 860 (2 ml inoculation milk/L) and dosed with Protex 7 L in glass beakers, so that the final NP7L concentration per kilo milk substrate is 8.9, 16.9, 33.8, 50.7, 67.6 and 101.4 ug (microgram). The fermentation was performed at 43° C. and stopped when pH was reached at 4.60. Afterwards the beakers were stirred for 15 seconds with a hand mixer and stored at 5° C. overnight. The viscosity measurements were performed the following day, after 20 hours in cold storage (5° C.). A dosage of 26.4 ul per 100 g yogurt gave the highest increase in viscosity comparing to no enzyme control by 10%.

From FIG. 37 it can be seen that this fluorescence assay method had a detection limit of 2 ppb (0.12 ng in 52.5 ul). Furthermore it can be seen that NP7L had at least 15 times lower activity at pH4.6 in the finished fermented yogurt product than in a buffer system at pH7.0 (0.25M Mops-NaOH having 5 mM CaCl2 and 0.1% Tween 80) by comparing the initial reaction velocity of the same amount of active NP7L enzyme protein. From FIG. 37 it can further be seen that a dose of NP7L of 0.54 ng, an active enzyme protein of 0.54 ng/50 ul yogurt, gave 10% increase in viscosity compared to the no enzyme control which had little assayable activity for a reaction time of 60 min at 40° C.

### Example 2: Texturing of Stirred Yogurt Applying NP7L

Pre-pasteurised (72° C.; 15 s) bulk blended skim milk (Arla Foods, Brabrand, Denmark) was obtained and stored at 4-6° C. Upfront, the skim milk was standardised in terms of protein (4.0% (w/v)) and fat (0.1% (w/v)). The standardised milk was subjected to pasteurisation in an autoclave (90° C.; 10 min). Subsequently, the milk was cooled to 43° C., aliquoted in 100 ml glass beakers, and inoculated with either YO-Mix 465, 532, 860 or 414 (each 20 DCU; DuPont Culture Units), respectively. These commercially available cultures are known to have differing textures. At the same time, 0.9 Units NP7L (see example 1) were added per 100 ml inoculated milk. The fermentation was conducted in a water bath at 43° C.

As soon as pH 4.6 was reached, the fermented milk was stirred for exactly 15 s with a hand mixer (IdeenWelt, Rossmann, Germany). Subsequently, the Yogurts were cooled in a water bath to 25° C., and following to 4-6° C. in a cold room. The stirred Yogurts were stored for 28 days, whereas flow curves were measured after 5-7, 14 and 28 days of storage.

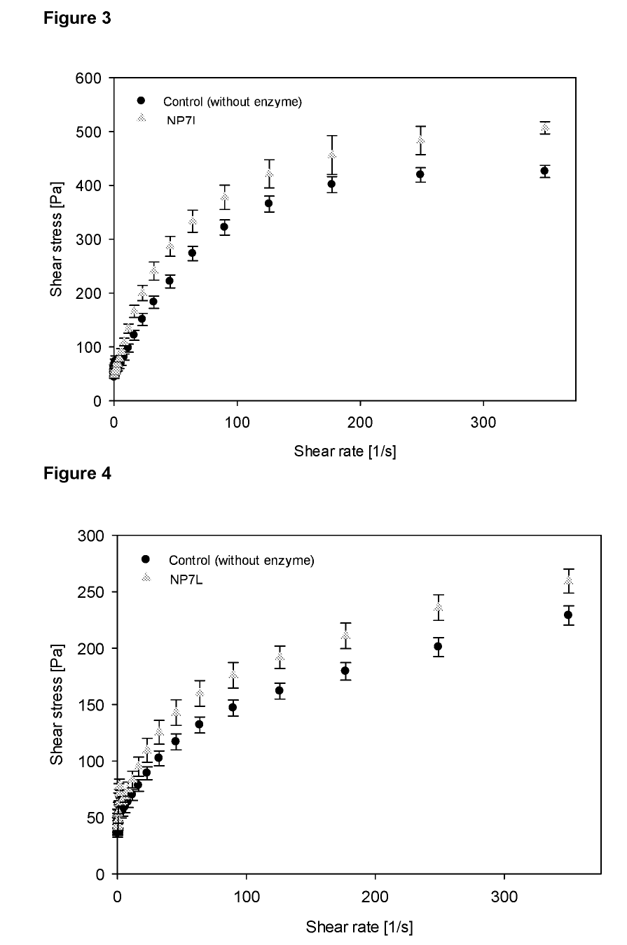

Flow curves were conducted applying the MCR302 rheometer from Anton Paar (vane ST22-4V-40-SN30845) employing a shear rate \dot{γ}ᵤₚ=0.1−350 s⁻¹ and \dot{γ}_{down}=350-0.1 s⁻¹. The results of apparent viscosity are shown in the FIGS. 1-4.

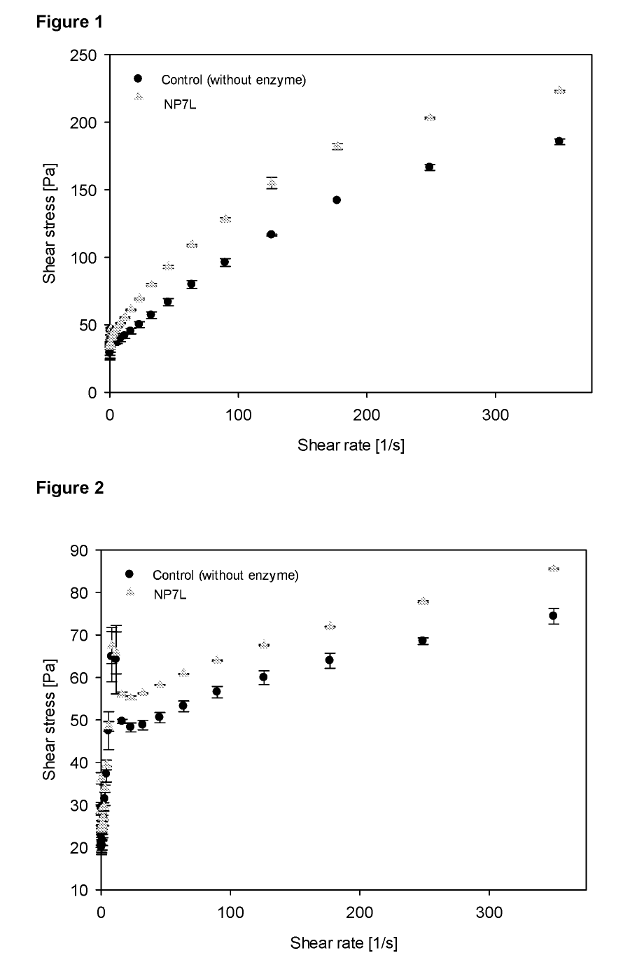

Higher viscosity in enzymated Yogurt was obtained over shelf life for all applied starter cultures. Applying the culture YO-Mix 465, an increase of 20% shear stress at a shear rate of 350 [1/s] after 14 days of storage was detected (FIG. 1). After 6 and 28 days, 12 and 10% higher shear stress was determined, respectively. Similar results were measurable applying the cultures YO-Mix 532, 860 and 414. The increase of the shear stress was between 10 and 20% each (FIGS. 2-4). No taste defect or modification of the acidification rate in presence of NP7L was detected.

### Example 3: Texturing of Stirred Yogurt Applying NP7L—Scale Up to 5 L

Pre-pasteurised (72° C.; 15 s) bulk blended skim milk (Arla Foods, Brabrand, Denmark) was obtained and stored at 4-6° C. Upfront, the skim milk was standardised in terms of protein (4.0% (w/v)) and fat (0.1% (w/v)). The standardised milk was subjected to pasteurisation in an autoclave (90° C.; 10 min). Subsequently, the milk was cooled to 43° C., aliquoted in 5 l vats, and inoculated with YO-Mix 465 (20 DCU; DuPont Culture Units). At the same time, 45 Units NP7L (see example 1) were added per 5 l inoculated milk. The fermentation was conducted at 43° C. in a water bath. Pilot plant equipment was applied for stirring and cooling instead of a hand mixer and a water bath. As soon as pH 4.6 was reached, the fermented milk was stirred at 43° C. and cooled to 25° C. using a tailor-made plate heat exchanger with a smoothening valve (Service Teknik, Randers, Denmark) employing 2 bar backpressure. Subsequently, the Yogurts were aliquoted in beakers (100 ml) and following cooled to 4-6° C. in the cold room. The stirred Yogurts were stored for 28 days, whereas flow curves were measured after 5-7, 14 and 28 days.

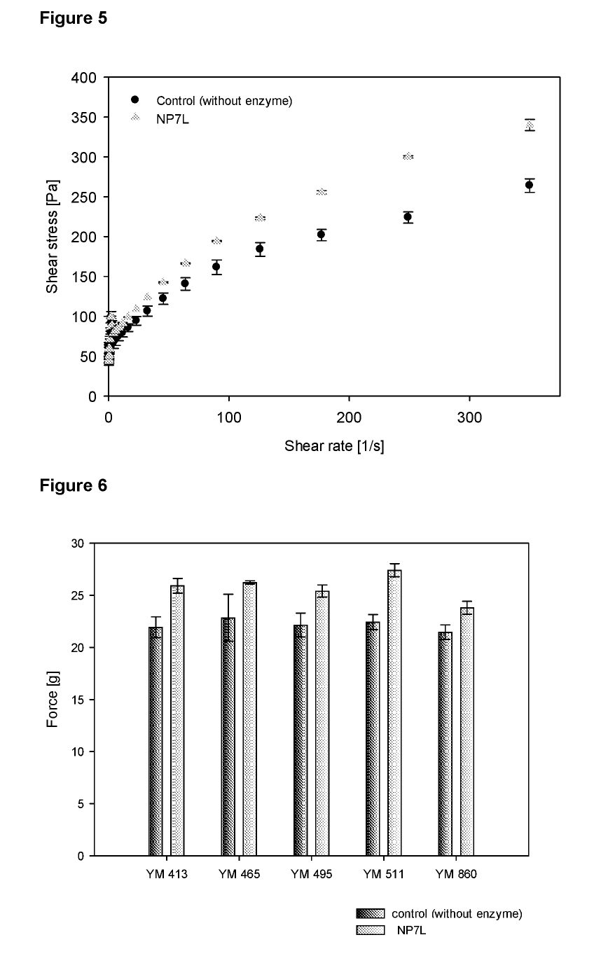

Flow curves were conducted applying the MCR302 rheometer from Anton Paar (vane ST22-4V-40-SN30845) employing a shear rate \dot{γ}ᵤₚ=0.1-350 s⁻¹ and \dot{γ}_{down}=350-0.1 s⁻¹. The result of apparent viscosity after 28 days of storage is shown in FIG. 5.

After the Scale-up from 100 ml to 5 l, the shear stress increased after 6, 14 and 28 days of storage by 11, 12 and 29%, at a shear rate of 350 [1/s], respectively.

### Example 4: Set Style Yogurt Applying NP7L

Pre-pasteurised (72° C.; 15 s) bulk blended skim milk (Arla Foods, Brabrand, Denmark) was obtained and stored at 4-6° C. Upfront, the skim milk was standardised in terms of protein (4.0% (w/v)) and fat (0.1% (w/v)). The standardised milk was subjected to pasteurisation in an autoclave (90° C.; 10 min). Subsequently, the milk was cooled to 43° C., aliquoted in 100 ml glass beakers, and inoculated with either YO-Mix 413, 465, 495, 511 or 860 (each 20 DCU; DuPont Culture Units), respectively. At the same time, 0.9 Units NP7L (see example 1) were added per 100 ml inoculated milk. The fermentation was conducted at 43° C. in a water bath.

As soon as pH 4.6 was reached, the Yogurts were cooled in a water bath to 25° C., and following to 4-6° C. in a cold room. The Yogurts were stored for 28 days, whereas texture profile analyses were measured after 5-7, 14 and 28 days.

The force needed to penetrate the set yogurt was measured via texture profile analyzer (TA-XT2i texture analyzer, Stable Micro Systems, Godalming Surrey, UK) employing the geometry SMS-P/0.5R. The highest peak of the positive area occurring during the TPA was used as an indicator for the force needed to penetrate the yogurt. The results after 5 days of storage are shown in FIG. 6.

A higher stiffness of the yogurt curd of the enzymated Yogurt was obtained for all applied cultures over shelf life (28 d). The presence of NP7L during fermentation did not result in the formation of syneresis.

### Example 5: Application of NP7L in Conjunction with Mesophilic Cultures

Pre-pasteurised (72° C.; 15 s) bulk blended skim milk (Arla Foods, Brabrand, Denmark) was obtained and stored at 4-6° C. Upfront, the skim milk was standardised in terms of protein (4.0% (w/v)) and fat (0.1% (w/v)). The standardised milk was subjected to pasteurisation in an autoclave (90° C.; 10 min). Subsequently, the milk was cooled to 25° C., aliquoted in 100 ml glass beakers, and inoculated with either Choozit 220, Choozit 230 or Probat 505 (each 20 DCU; DuPont Culture Units), respectively. These are commercially available inoculates. At the same time, 0.9 Units NP7L (see example 1) were added per 100 ml inoculated milk. The fermentation was conducted at 27° C. in a water bath.

As soon as pH 4.6 was reached, the fermented milk was stirred for exactly 15 s with a hand mixer (IdeenWelt, Rossmann, Germany). Subsequently, the Yogurts were cooled to 4-6° C. in a cold room. Flow curves were measured after 5 days of storage.

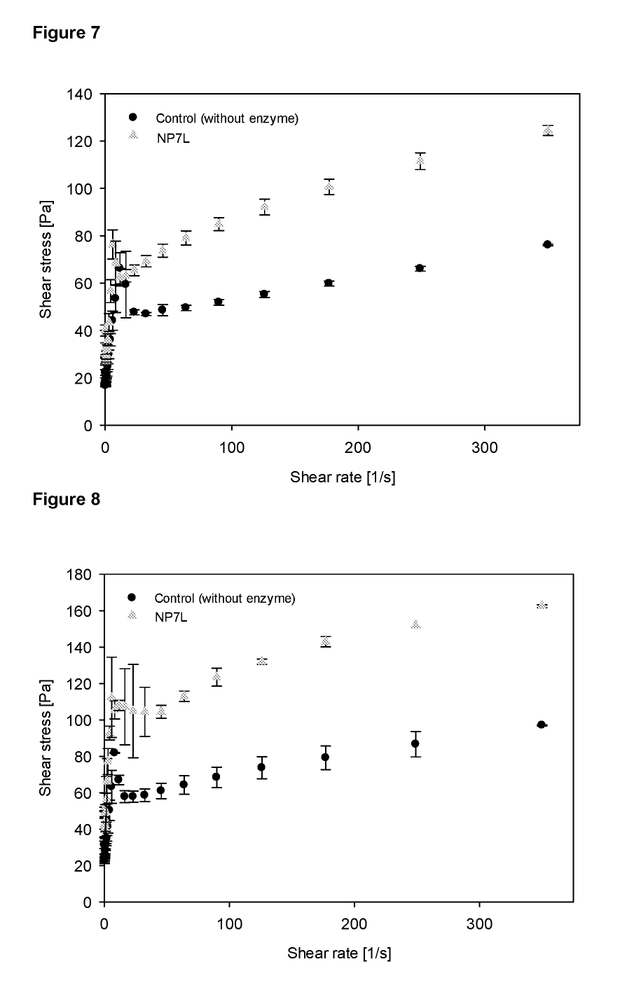

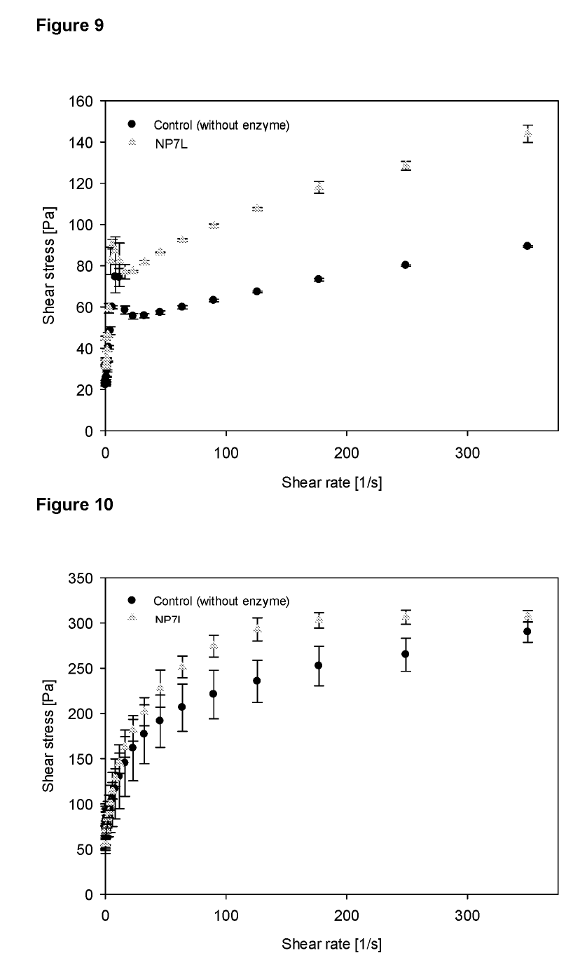

Flow curves were conducted applying the MCR302 rheometer from Anton Paar (vane product number ST22-4V-40-SN30845) employing a shear rate \dot{γ}ᵤₚ=0.1-350 s⁻¹ and \dot{γ}_{down}=350-0.1 s⁻¹. The results are shown in the FIGS. 7-9.

For all mesophilic cultures a higher viscosity in the enzymated Yogurt was obtained. After 5 days of storage, about 60% increased shear stress at shear rate of 350 [1/s] was detected for all mesophilic cultures.

### Example 6: Application of NP7L in Conjunction with the Thermophilic YO-Mix 465 Culture at 30-43° C. in Stirred and Set Style Yogurts

Pre-pasteurised (72° C.; 15 s) bulk blended skim milk (Arla Foods, Brabrand, Denmark) was obtained and stored at 4-6° C. Upfront, the skim milk was standardised in terms of protein (4.0% (w/v)) and fat (0.1% (w/v)). The standardised milk was subjected to pasteurisation in an autoclave (90° C.; 10 min). Subsequently, the milk was cooled to 43° C., 37° C. or 30° C., aliquoted in 100 ml glass beakers and inoculated with YO-Mix 465 (20 DCU; DuPont Culture Units), respectively. At the same time, 0.9 Units NP7L (see example 1) were added per 100 ml inoculated milk. The fermentations were conducted at 30, 37 and 43° C. in water baths.

As soon as pH 4.6 was reached, the fermented milk was stirred for exactly 15 s with a hand mixer (IdeenWelt, Rossmann, Germany). Subsequently, the Yogurts were cooled in a water bath to 25° C., and following to 4-6° C. in a cold room. The set style Yogurt was cooled immediately to 25° C. in the same way. All Yogurts were stored for 28 days, whereas flow curves and texture profile analyses were measured after 5-7, 14 and 28 days for stirred and set style yogurt, respectively.

Flow curves were conducted applying the MCR302 rheometer from Anton Paar (vane ST22-4V-40-SN30845) employing a shear rate \dot{γ}ᵤₚ=0.1-350 s⁻¹ and \dot{γ}_{down}=350-0.1 s⁻¹. The oscillation for the strain sweep was set to 0.01-500% at a frequency of 1 Hz. The force needed to penetrate the set yogurt was measured employing a texture profile analyzer (TA-XT2i texture analyzer, table Micro Systems, Godalming Surrey, UK) (TPA) employing the geometry SMS-P/0.5R. The highest peak of the positive area occurring during the TPA was used as an indicator for the force needed to penetrate the yogurt. The resulting shear stress of non enzymated and enzymated stirred yogurt as well as the curd stiffness of set style yogurt are shown in the FIGS. 10-12.

The shear stress of enzymated stirred yogurt, fermented at 43° C., increased by 6%, compared to 27 and 34% at the fermentation temperatures at 37 and 30° C. (FIGS. 10 and 11), respectively.

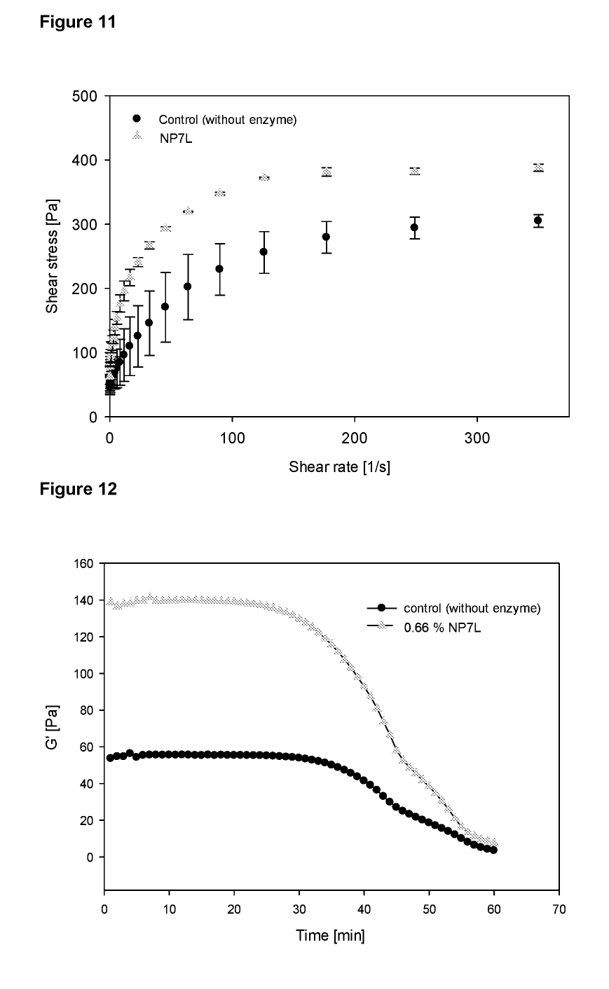

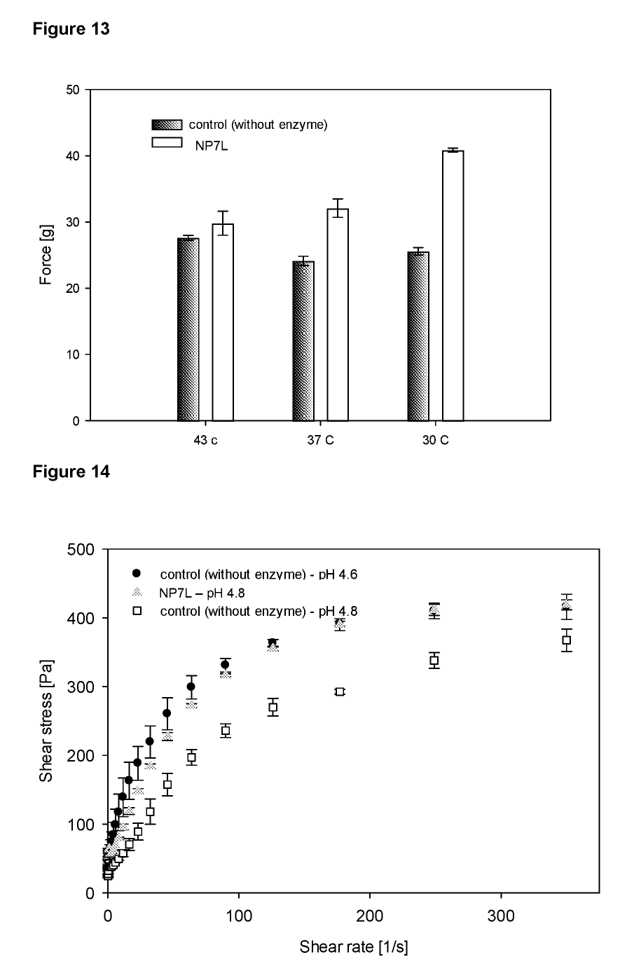

Furthermore, the storage modulus (G′) increased by about 150% higher storage modulus G′, indicating increased gel firmness, of the enzymated stirred yogurt, compared to the reference at 37° C. (FIG. 12). Similar results were obtained with the profile texture analyses (FIG. 13). A higher curd stiffness of the enzymated yogurt applying lower fermentation temperatures was detected. For both yogurt types, stirred and set style, no increased syneresis formation was observed.

It can therefore be seen that fermented milk products of the current invention have increased gel strength and viscosity.

### Example 7: Application of NP7L at 43° C. to Produce a Milder Stirred Yogurt (pH 4.8 Instead of 4.6)

Pre-pasteurised (72° C.; 15 s) bulk blended skim milk (Arla Foods, Brabrand, Denmark) was obtained and stored at 4-6° C. Upfront, the skim milk was standardised in terms of protein (4.0% (w/v)) and fat (0.1% (w/v)). The standardised milk was subjected to pasteurisation in an autoclave (90° C.; 10 min). Subsequently, the milk was cooled to 43° C., aliquoted in 100 ml glass beakers, and inoculated with YO-Mix 860 (20 DCU; DuPont Culture Units), respectively. At the same time, 0.9 Units NP7L (see Example 1) were added per 100 ml inoculated milk. The fermentation was conducted at 43° C. in a water bath.

As soon as the desired pH (pH 5.0, 4.9, 4.8, 4.7 or 4.6) was reached, the yogurt was stirred for exactly 15 seconds with a hand mixer (IdeenWelt, Rossmann, Germany). Subsequently, the Yogurts were cooled in a water bath to 25° C., and following to 4-6° C. in a cooled room. The Yogurts were stored for 28 days, whereas flow curves were measured after 5-7, 14 and 28 days.

Flow curves were conducted applying the MCR302 rheometer from Anton Paar (vane ST22-4V-40-SN30845) employing a shear rate \dot{γ}ᵤₚ=0.1-350 s⁻¹ and \dot{γ}_{down}=350-0.1 s⁻¹. The results of apparent shear stress are shown in FIG. 14. FIG. 14 clearly shows that NP7L treated yogurt wherein the fermentation is stopped at pH4.8 has same sheer strength as untreated yogurt where fermentation stopped at pH4.6. This results in a less acidic yogurt with same shear strength, which is also quicker to produce. Applying the culture YO-Mix 860 (without enzymation), a shear stress of about 400 Pa was detected after 5 days of storage. A comparable shear stress was obtained in enzymated yogurt, which was stopped at pH 4.8 instead of pH 4.6. For non enzymated yogurt, which was stopped at pH 4.8 instead of pH 4.6, an about 10% lower shear stress at a shear rate of 350 [1/s] was observed.

This example demonstrates that the methods of the current invention can surprisingly be used to produce a fermented milk product which is less acidic, but otherwise has similar properties to a fermented milk product not treated with a low pH sensitive peptidase.

### Example 8: Protein Replacement Applying NP7L

Pre-pasteurised (72° C.; 15 s) bulk blended skim milk (Arla Foods, Brabrand, Denmark) was obtained and stored at 4-6° C. Upfront, the skim milk was standardised in terms of protein (5.0% (w/v)) and fat (0.1% (w/v)). The standardised milk was subjected to pasteurisation in an autoclave (90° C.; 10 min). In order to achieve the desired protein contents of 3.6, 3.7, 3.8, 3.9, 4.0, 4.1 or 4.2%, the milk was dissolved with sterile H₂O after pasteurisation. Subsequently, the milk was cooled to 37° C., aliquoted in 100 ml glass beakers, and inoculated with YO-Mix 465 (20 DCU; DuPont Culture Units), respectively. At the same time, an appropriate amount of NP7L, which was adjusted to each particular protein concentration, (0.9 Units, see example 1) was added per 100 ml inoculated milk. The fermentation was conducted at 37° C. in a water bath.

As soon as pH 4.6 was reached, the yogurt was stirred for exactly 15 s with a hand mixer (IdeenWelt, Rossmann, Germany). Subsequently, the Yogurts were cooled in a water bath to 25° C., and following to 4-6° C. in a cooled room. The Yogurts were stored for 28 days, whereas flow curves were measured after 5-7, 14 and 28 days.

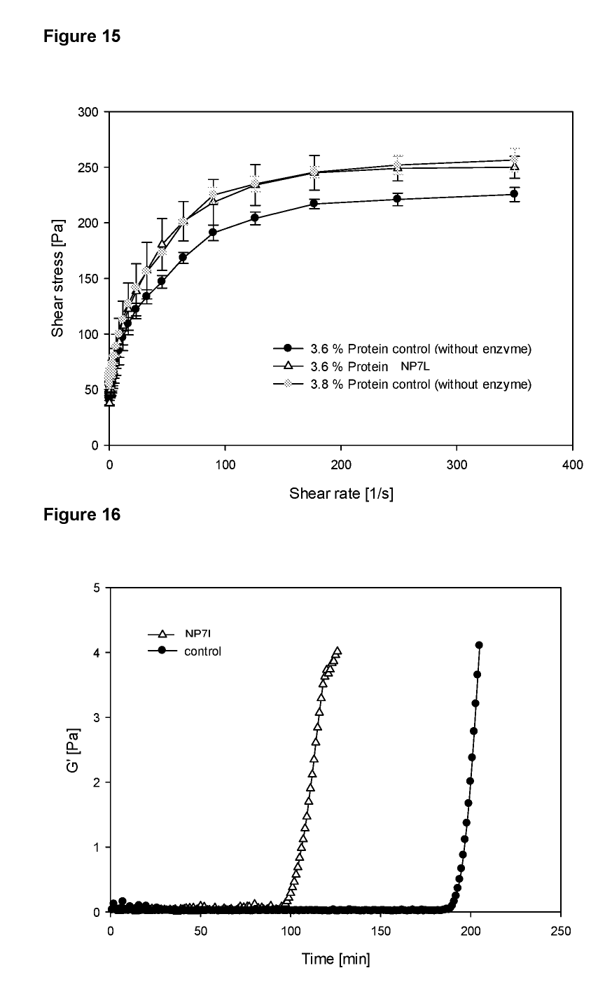

Flow curves were conducted applying the MCR302 rheometer from Anton Paar (vane ST22-4V-40-SN30845) employing a shear rate \dot{γ}ᵤₚ=0.1-350 s⁻¹ and \dot{γ}_{down}=350-0.1 s⁻¹. The results of apparent shear stress are shown in FIG. 15.

Applying to 3.8% Protein standardised low fat milk (0.1% fat) and the culture YO-Mix 465 (without enzymation), a shear stress of about 250 Pa was detected after 5 days of storage. A comparable shear stress was obtained in enzymated yogurt applying 3.6% instead of 3.8% protein. Therefore the current invention clearly reduced the percentage of protein needed. To make a product with the same texture without using a peptidase requires increased protein, preferably 4% protein.

### Example 9: Simulation of the Fermentation—Formation of the Yogurt Gel

Pre-pasteurised (72° C.; 15 s) bulk blended skim milk (Arla Foods, Brabrand, Denmark) was obtained and stored at 4-6° C. Upfront, the skim milk was standardised in terms of protein (4.0% (w/v)) and fat (0.1% (w/v)). The standardised milk was subjected to pasteurisation in an autoclave (90° C.; 10 min). Subsequently, the milk was cooled to 43° C., inoculated with YO-Mix 465 (20 DCU; DuPont Culture Units) and aliquoted in Aluminium Cups (rheometer equipment, Anton Paar, Ostfildern, Germany), 40 ml each. At the same time, 0.36 Units NP7L (see example 1) were added per 40 ml inoculated milk. The fermentation was simulated using the rheometer MCR302 from Anton Paar (vane ST22-4V-40-SN30845). The Simulation was conducted over 6 h at 43° C., whereas an oscillation of γ=0.02% and f=1 Hz was applied. The storage modulus G′ was detected every minute. The results are shown in FIG. 16.

The formation of the yogurt gel started about 1.5 h earlier in the enzymated yogurt milk compared to non enzymated yogurt milk.

### Example 10—Comparison with a Chymosin

Pre-pasteurized (72° C.; 15 s) bulk blended low fat milk (Arla Foods, Brabrand, Denmark) stored at 4-6° C. was standardized with regard to protein (4% (w/v)) and fat (1.5% (w/v)). The standardized milk was subjected to pasteurization in an autoclave (90° C.; 10 min) and stored at 4-6° C. afterwards. The cold milk was distributed in 100 ml glass beakers and inoculated with Yo-Mix 860 with an inoculation rate of 20 DCU/100 L. At the same time, 0.9 units NP7L or 100 μL Marzyme 10 were added per 100 mL of milk, respectively. The fermentation was conducted at 43° C. Marzyme 10 is a fungal origin chymosin-type enzyme. That is a specific aspartic endopeptidase which is employed for cheese manufacturing.

As soon as pH 4.6 was reached the fermented milk was stirred for exactly 15 s with a hand mixer (IdeenWelt, Rossmann, Germany). The resulting yogurts were cooled in a water bath to 25° C. and following kept at 6° C. storage.

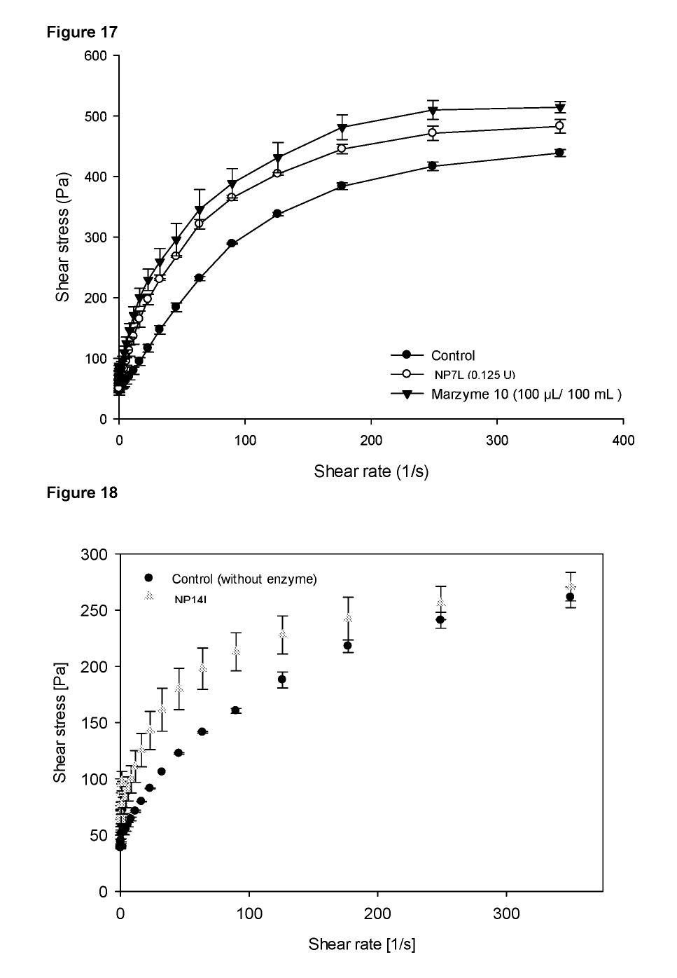

Flow curves were attained with the MCR302 rheometer (Anton Paar GmbH, USA) and vane ST22-4V-40-SN30845 employing shear rates \dot{γ}ᵤₚ=0.1-350 s⁻¹ and \dot{γ}_{down}=350-0.1 s⁻¹. Results obtained from the rheometer are shown in FIG. 17. As shown, in FIG. 17, both enzymes increased the dynamic viscosity compared to the control (without enzyme).

### Example 11—Texturing of Stirred Yogurt Applying NP14L

As per Example 2, Pre-pasteurized (72° C.; 15 s) bulk blended low fat milk (Arla Foods, Brabrand, Denmark) stored at 4-6° C. was standardized with regard to protein (4% (w/v)) and fat (1.5% (w/v)). The standardized milk was subjected to pasteurization in an autoclave (90° C.; 10 min) and stored at 4-6° C. afterwards. The cold milk was distributed in 100 ml glass beakers and inoculated with Yo-Mix 465 with an inoculation rate of 20 DCU/100 L. At the same time, 26.4 μL (200 times diluted) Protex 14L was added. The fermentation was conducted at 43° C.

As soon as pH 4.6 was reached the fermented milk was stirred for exactly 15 s with a hand mixer (IdeenWelt, Rossmann, Germany). The resulting yogurts were cooled in a water bath to 25° C. and following kept at 6° C. storage for 6 days.

Flow curves were attained with the MCR302 rheometer (Anton Paar GmbH, Germany) and vane ST22-4V-40-SN30845 employing shear rates \dot{γ}ᵤₚ=0.1-350 s⁻¹ and \dot{γ}_{down}=350-0.1 s⁻¹. Results obtained from the rheometer are shown in FIG. 18. As shown, in FIG. 18, Protex 14L did increase the viscosity compared to the control (without enzyme) after 6 days of storage.

Protex 14L has only 48.1% identity to NP7L (see FIG. 45) yet show similar properties in yogurt.

### Fungal Peptidase Examples

### Example 12—Isolating and Testing a Fungal Peptidase

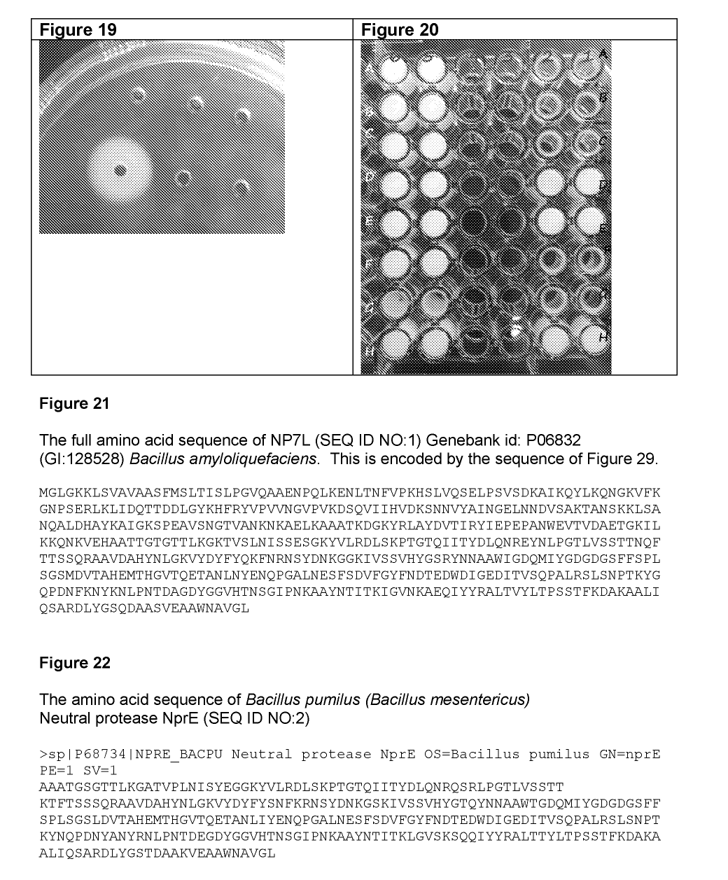

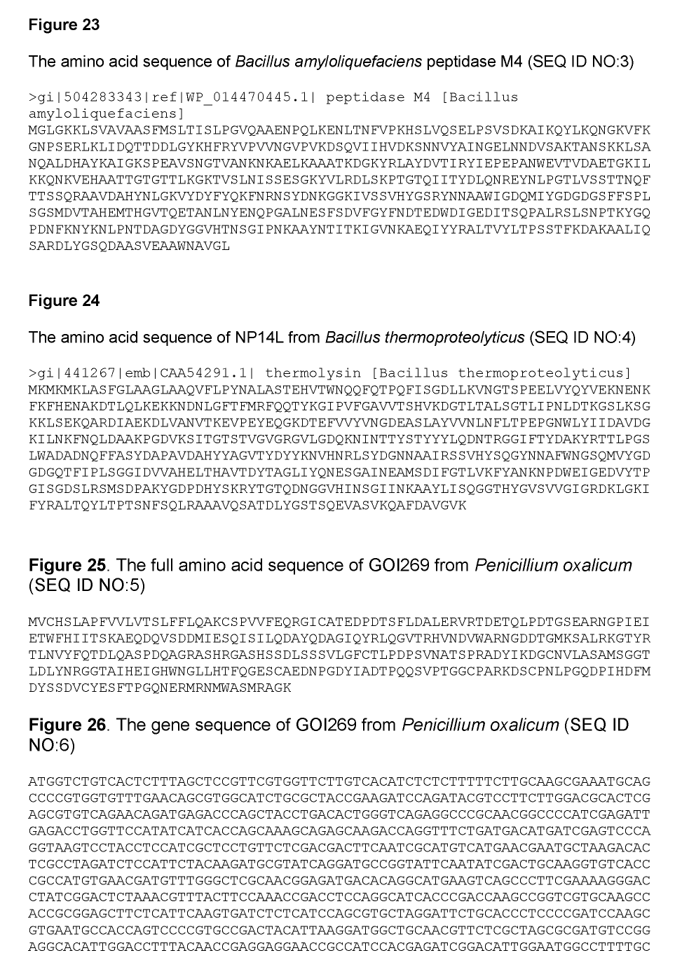

The fungal metalloprotease GOI269 was examined for coagulating the milk protein casein. The results are shown in FIG. 19. The agarose plate had 1% casein in 1% agarose in 0.1M McIlvaine buffer (pH6.0). 10 ul GOI269 (protein concentration, 0.81 mg/ml) was loaded to the well. The photo was taken after overnight incubation at 37° C. One can see that GOI269 could well hydrolyze casein and develop a whitish hallo.

### Example 13—Fungal Metalloprotease for Coagulating Milk

The fungal metalloprotease GOI269 was further examined for coagulating milk. To the wells of A1 to H2 of a 96 MTP were added 5 ul buffer with indicated pH, 0.2M EDTA or water (Table 1), and 5 μl GOI269, mixed and incubated at 40° C. for 90 min in a water bath. At the end of the incubation, 190 μl low fat milk containing 0.1% fat, 4.7% sugar and 3.5% protein from Arla (www.arla.dk/) was added to Well A1-H2, mixed and incubated at 37° C. overnight. The photo was taken after the plate was placed upside down against paper tissue so that wells with uncoagulated milk were absorbed by the tissue. For Well A5-H6, 190 μl low fat were added directly after mixing 5 μl GOI269 with 5 μl of the solutions indicated in table 1 and the rest procedure was the same as Well A1-H2.

TABLE 1

| Wells | A | B | C | D | E | F | G | H |
|---|---|---|---|---|---|---|---|---|
| Buffers | 0.1M | 0.1M | 0.1M | 0.1M | 0.1M | 0.1M | 0.2M | water |
| | HAC- | HAC- | HAC- | HAC- | Mes- | Mops- | EDTA | |
| | NaAC | NaAC | NaAC | NaAC | NaOH | NaOH | | |
| pH | 4.14 | 4.56 | 5.01 | 5.55 | 6.01 | 7.00 | — | — |

Results: For wells of A5-F6 and H5-H6 in FIG. 20, the low fat milk was coagulated in the presence of GOI269, that is, GOI269 protease was active at the pH of milk. For wells G5-G6 having EDTA at a final concentration of 5 mM, the milk was not coagulated. It is well known that chelators like EDTA can well inhibit metalloproteases which have divalent metal ions for catalysis and maintaining 3D structure.

Wells A1-H2 (shown in FIG. 20) were treated the same as Well A5-H6 except the mixture was pre-incubated at 40° C. for 90 min before adding the milk and further incubated at 37° C. overnight. One can see that only Wells of D1-D2 (pH5.55), Wells of E1-E2 (pH 6.01) and Well H1-H2 (water) had coagulated milk. This indicates that GOI269 is instable at pH4.14 to 5.01. Such properties of a metalloprotease for yogurt are highly desirable. That is, the metalloprotease should be active to coagulate milk at milk's pH (Wells H1-2) and it should be inactivated when pH is being brought to pH5 or below (Wells A1-02) by growth and fermentation of starter cultures that produce organic acids including lactic acids from milk sugars.

### Example 14—Expression and Production of the Fungal Metalloprotease GOI269

The extracellular metalloprotease A0090012001025 from Penicillium oxalicum (FIG. 25 for amino acid sequence and FIG. 26 for gene sequence) was cloned and expressed in Trichoderma reesei as described in other DuPont/Genencor patent applications, such as WO2009/100183, Examples 4-8; and US 2012/0225469 A1, Examples 1-3. The fermented broth was ultrafiltered to remove the cells and was used in these tests. In control Trichoderma reesei fermented broth did not give such reaction.

The Penicillium oxalicum metallopeptidase GOI269 sequence in FIG. 25 has 58.8% identity to an extracellular metalloprotease A0090012001025 (www.uniprot.org/uniprot/Q2UBF0) from Aspergillus oryzae (FIG. 28).

### Example 15—Comparison to Other Enzyme Classes

Table 2 lists proteases, carbohydrases and lipases that were not able to improve the yogurt texture in terms of viscosity increase. This table gives Negative Examples of enzyme that did not improve the yogurt text in terms of viscosity increase). “0” means no effect in viscosity increase.

From Table 2 one can see that not all enzymes will work in yogurt even though there are substrates for these enzymes in the yogurt production process. For example lipase from A. niger was not found to give increased viscosity for yogurt and alpha-galactosidases from either A. niger or Trichoderma reesei was found to give any positive effect either even though it has been hypothesized that alpha-galactosidases can hydrolyze the carbohydrate moiety of milk proteins and thereby decrease their solubility and increase the dairy product viscosity (Jacobsen et al., 2012). Furthermore proteases listed are Table 2, which represent the 3 major protease families, i.e., aspartic protease family, cysteine protease family and serine protease family, all failed to increase the yogurt viscosity.

The enzymes tested in table 2 are not low-pH sensitive. For example, the food grade acidic fungal protease Protex 15L from Trichoderma reesei from DuPont (US2012/0225469 A1) is likely to not be active enough in fresh milk, as its optimal pH is around pH3.8. The failure for the other proteases such as papain may be due to their higher activity at pH4.6 For example, the food grade protease papain retains more than 70% of its activity at pH4.6 compared to pH6.7 (Hoover and Kokes, 1947). For Proteinase K, its wide substrate specificity that hydrolyzes milk proteins at multiple sites leading to extensive hydrolysis converting milk protein polymers to oligomers which have lowered viscosity could be its failure mechanism (Petrotchenko et al., 2012).

TABLE 2

| | | | Effect (viscosity |
|---|---|---|---|
| Name | Enzyme family | Suppliers | increase vs. control) |
| Alpha-galactosidase | GH36 | Megazyme | 0 |
| from Aspergillus niger, | (EC 3.2.1.22) | International | |
| product code: E-AGLANP | | Ireland | |
| The three Alpha- | GH27 and | Experiment samples | 0 |
| galactosidases from | GH36 | from, DuPont Denmark | |
| Trichoderma reesei | | prepared with reference | |
| AGLI, AGLIII (GH27) | | to Margolles-Clark (Eur J | |
| and AGLII(GH36) | | Biochem. 1996; | |
| | | 240: 104-111) | |
| Amano Lipase A from | | Amano Enzyme Inc. | 0 |
| Aspergillus niger, | | Japan. Obtained from | |
| cat no. 534781 | | Sigma- Aldrich | |
| Acidic fungal protease | Food grade | DuPont Denmark | 0 |
| Protex 15L from | Aspartic protease | | |
| Trichoderma reesei | | | |
| Proteinase K from | Serine peptidase | Roche Life Science | 0 |
| Engyodontium album | | Denmark | |
| (syn. Tritiachium album), | | | |
| Product No. 03115879001 | | | |
| Protex 6L from | Food grade | DuPont Denmark | 0 |
| Bacillus licheniformis | Serine peptidase | | |

### Example 16

### Texture Increase in Sour Cream Employing NP7L

Pre-pasteurized skim milk (72° C.; 15 sec) was standardised in terms of fat (5.0 and 9.0% (w/w)) with cream 38% fat (w/w) which resulted in a protein content of 3.7% and 3.5% (w/w) for the 5% and 9% fat containing sour cream base, respectively. In a further trial, the milk was standardized to protein and fat of 4.2% (w/w) protein and 5% (w/w) fat as well as 4.2% (w/w) protein and 9% (w/w) fat. The standardised milk was subjected to pasteurisation in a plate heat exchanger (PHE; 95° C.; 6 min). Subsequently, the milk was cooled to 4° C. for overnight storage and later reheated to 45° C. and cooled down to 22° C. to avoid fat crystallisation and inoculated with Probat™ 505 (7 DCU/100L; DuPont Culture Units) and Lactococcus lactis subsp. cremoris at 3 gram/100L, respectively. At the same time, an appropriate amount of NP7L (6.3-8.5 U*l⁻¹), which was adjusted to each particular protein concentration, was added per 100 ml inoculated milk. The fermentation was conducted at 22° C. in a water bath in 5 liter vats for about 16-18 hours. As soon as pH 4.6 was reached, the sour cream fermentation was terminated, stirred manually and smoothened through a plate heat exchanger in-series with a Ytron-Z 1.50FC-2.0.1 (YTRON Process technology GmbH, Bad Ensdorf, Germany) adjusted to level 5 (5%) followed by filling in cups and storage in a cold room at 4-6° C. The sour cream samples were stored for 28 days, whereas flow curves were measured after 14 days using a cone plate method.

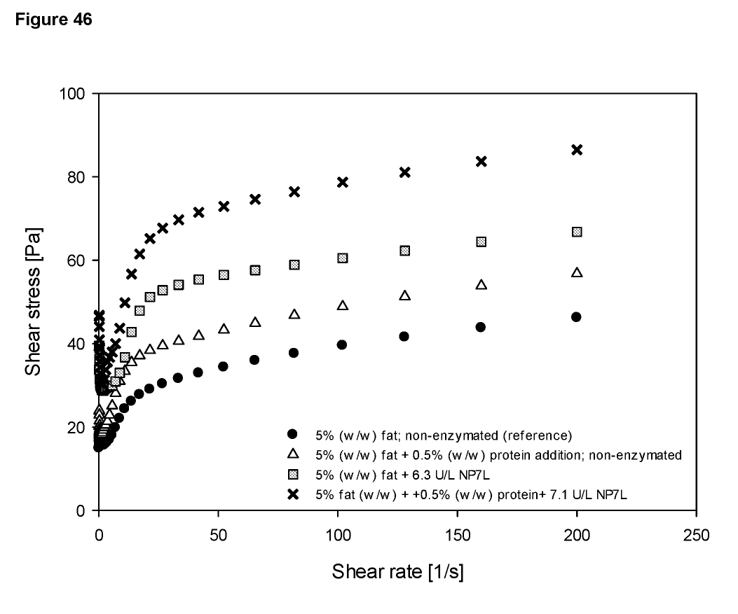

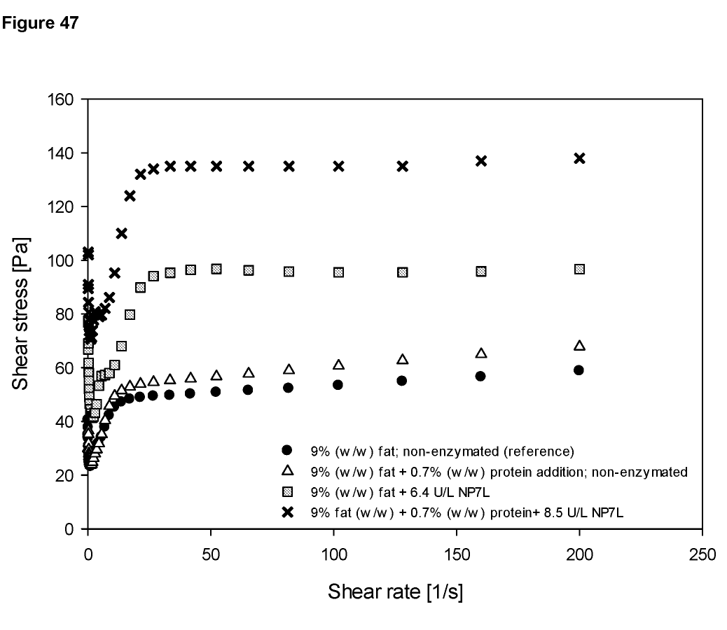

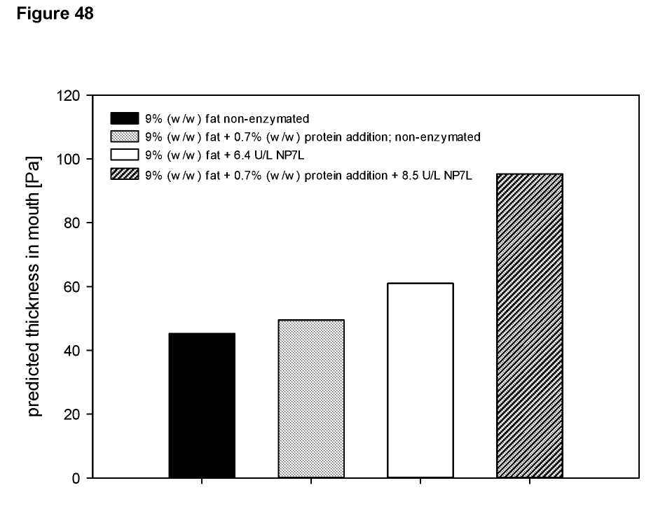

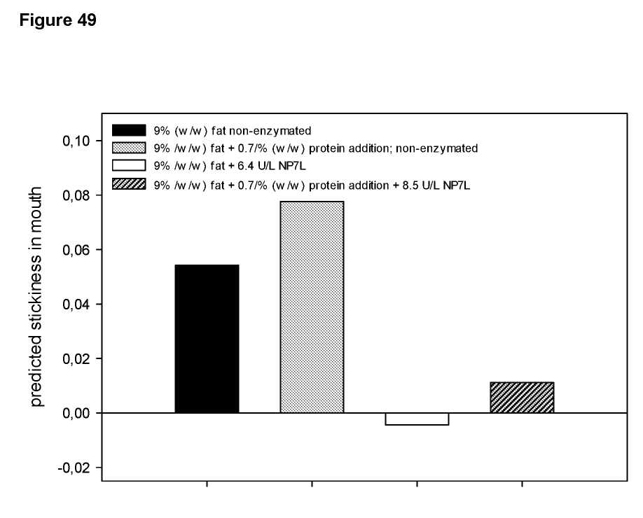

Upon the application of NP7L, the apparent viscosity (FIGS. 46 and 47) as well as the predicted “thickness in mouth” (extracted shear stress at a shear rate of 10 s*⁻¹; FIG. 48) were significantly increased by the addition of NP7L. Overall, the texture of the product was dominated by the thickness (slope of the linear regression of the shear rate range of 33-160 s*⁻¹) of the produced sour cream. Moreover, the stickiness in mouth was significantly reduced due to the fact the slope of the enzymated sour cream has a negative slope or is less steep compared to the non-enzymated reference (FIG. 49). A direct correlation between NP7L dosage and final Sour Cream viscosity was observed as well (data not shown).

### Example 17

Sensory Analysis of Sour Cream with and without the Addition of NP7L

The 18% (w/w) fat containing sour cream base was made as follows. Skimmed milk (3166 g) and cream 38% fat (˜2834 g) were mixed under good agitation at 45° C. and subjected to homogenization and pasteurization at 95° C. for 6 minutes (P1: 65° C.; homogenization 80 bar P2: 80° C.; P3: 95° C. for 6 minutes). Following the pasteurization, the milk was cooled to 22° C. and the starter culture mixture was added (10 DCU/100L Probat™ M7 and Lactococcus lactis subsp. cremoris at 3 gram/100L). At the same time, between 5.1 and 8.5 U/L NP7L were added. The fermentation was conducted at 22° C. until pH 4.60 was measured. Next the sour cream was passed through a plate heat exchanger in-series with a Ytron-Z 1.50FC-2.0.1 (YTRON Process technology GmbH, Bad Ensdorf, Germany) adjusted to level 5 (5%) followed by filling in cups and storage in a cold room at 4-6° C. The final product had a fat content of 17.95% (w/w) and a protein content of 2.90% (w/w). The sour cream samples were stored at least for 5 days but no longer than 14 days and assessed by the sensory panel.

To describe the impact on sensory perceivable product attributes, descriptive sensory analysis is chosen. The basis for the descriptive analysis is ISO 13299 “Sensory analysis—Methodology—General guidance for establishing a sensory profile”. In the sensory descriptive analysis, the intensity of each descriptor is evaluated on a line scale with two anchor points indicating low and high intensity, respectively. The anchor points for low and high is taught to the panel in the training/calibration sessions. All samples are evaluated in triplicate. The sensory panel consists of 7 persons, who have all passed the basic sensory screening test before they are accepted in the panel before taking part in the descriptive analysis of this analysis. The panelists are trained in recognizing and intensity scaling of the product attributes. A definition of the attributes can be found in Table 3.

TABLE 3
Definition of tested attributes in the sensory assessment

| | |
|---|---|
| Uneven | Use the spoon to cut the sample, inspect the cut surface and |
| surface | evaluate how gritty/uneven the freshly cut surface is |
| Resistance - | Slowly stir the sample 5 times without letting the spoon |
| Spoon | touch the beaker. Evaluate the samples resistance against |
| | the spoon. “Much” is when much force is needed. |
| Thickflow - | Let some sample drip from the spoon held 5 cm above the |
| Spoon | beaker. “Much” is when it falls in lumps and “little” |
| | is when it runs continuously from the spoon to the beaker. |
| Thickflow - | Take some sample into your mouth. Evaluate its thickness. |
| Mouth | How much force is needed to press the tongue towards the |
| | palate? |
| Soft/Velvet | Take some sample into your mouth. Evaluate its softness |
| | by gently swirling the sample around in the oral cavity |
| | with your tongue. How velvet-like does the sample feel? |
| Fat | Take some sample into your mouth. Evaluate its fat content |
| perception | by gently swirling the sample around in the oral cavity |
| | with your tongue. |
| Acidity | Take a new spoonful of sample. Evaluate the intensity of |
| | acidic taste in your mouth. |
| Bitter | Evaluate the intensity of bitter taste in your mouth. |
| Sweetness | Evaluate the intensity of sweet taste in the mouth. |
| Flavor | In a new spoonful of sample, app. 5 ml, evaluate the |
| | harmony among flavors and the overall flavor/aroma |
| | intensity in the mouth. |

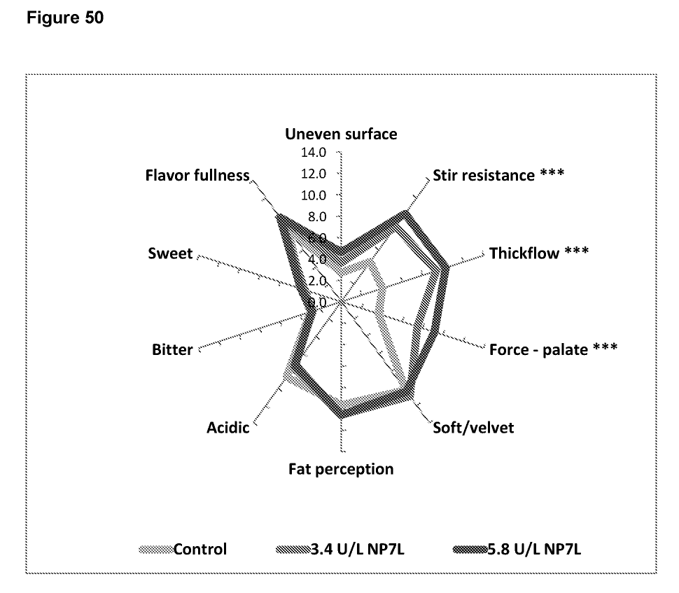

As shown in FIG. 50, the sensory attributes of uneven surface, flavor fullness, sweet, bitter, acidic, fat perception and soft/velvet remained non-significant upon the application of the NP7L in 18% fat (w/w) sour cream. However, all attributes related to viscosity were significantly increased (p<0.05), namely stir resistance, thickflow spoon and force-palate. There was no change in bitterness upon the application of the NP7L.

### LITERATURE

The following documents are cited herein and fully incorporated by reference:—
Ausubel et al (1999) Short Protocols in Molecular Biology, 4th Ed—Chapter 18
Altschul et al (1990) J. Mol. Biol. 403-410
Clarkson K A, Dunn-Coleman N, Lantz S E, Pilgrim C E, van Solingen P, Ward M. Acid Fungal Proteases, United States Patent Application Publication, US 2012/0225469 A1
De Greeftrial, N., Queguiner, C., Grugier, F., & Paquet, D. (2005). US Patent Publication No. US2005/0095316A1
Ebeling W, Hennrich N, Klockow M, Metz H, Hans Orth H D, and Lang H (1974), Proteinase K from Tritirachium album Limber. Eur. J. Biochem. 47, 91-97.
Filippova et al., (1996) Analytical Biochemistry 234, 113-118
Horwell D C, (1995) Trends Biotechnol. 13(4), 132-134
Hoover S R, Kokes E L (1947). Effect of pH upon proteolysis by papain. J Biol Chem. January; 167(1):199-207.
Iversen, S. L. and M. H. Jorgensen (1995). “Azocasein assay for alkaline protease in complex fermentation broth. Biotechnology Techniques 9(8): 573-576.
Jakobsen, J., Wnd, S. L., & Qvist, K. B. (2012). PCT publication No. WO2012/069546A1.
Levine et al., (2008) Molecules, 13, 204-211.
Mende, S., Peter, M., Bartels, K., Rohm, H., & Jaros, D. (2013). Addition of purified exopolysaccharide isolates from S. thermophilus to milk and their impact on the rheology of acid gels. Food Hydrocolloids, 32(1), 178-185.
Nascimento A S, Krauchenco S., Golubev A M, Gustchina A, Wodawer A, and Polikarpov I (2008), Statistical Coupling Analysis of Aspartic Proteinases Based on Crystal Structures of the Trichoderma reesei Enzyme and Its Complex with Pepstatin A. J Mol Biol. October 10; 382(3): 763-778
Omondi J G and Stark J R (2001) Studies on Digestive Proteases from Midgut Glands of a Shrimp, Penaeus indicus, and a Lobster, Nephrops norvegicus: part 1. App. Biochem. and Biotec. 90, 137-153
Petrotchenko E V, Serpa J J, Hardie D B, Berjanskii M, Suriyamongkol B P, Wishart D S, Borchers C H (2012). Use of proteinase K nonspecific digestion for selective and comprehensive identification of interpeptide cross-links: application to prion proteins. Mol Cell Proteomics. July; 11(7):M111.013524. doi: 10.1074/mcp.M111.013524 page 1-13. Epub 2012 Mar. 21.
Prasanna, P. H. P., Grandison, A. S., & Charalampopoulos, D. (2012). Effect of dairy-based protein sources and temperature on growth, acidification and exopolysaccharide production of Bifidobacterium strains in skim milk. Food Research International, 47(1), 6-12.
Queguiner, C., De Greeftrial, N., Grugier, F., & Paquet, D. (2005). US Patent Publication No. US2005/0095317A1.
Rawlings, N. D., & Barrett A. J, (1993) Evolutionary Families of Peptidases. Biochem. J. 290, 205-218.
Schechter and Berger, (1967) On the size of the active site in proteases. I. Papain. Biochem Biophys Res Commun, 27(2):157-162.
Simon R J et al., (1992) PNAS 89(20), 9367-9371 Sodini, I., Remeuf, F., Haddad, C., & Corrieu, G. (2004). The Relative Effect of Milk Base, Starter, and Process on Yogurt Texture: A Review. Critical Reviews in Food Science and Nutrition, 44(2), 113-137.
Tran, L., Wu, X. C., & Wong, S. L., (1991). Cloning and expression of a novel protease gene encoding an extracellular neutral protease from Bacillus subtilis. J. Bacteriol. 173(20), 6364-6372.
Worthington Enzyme Manual—Worthington, K., and Worthington, V., Eds. (1993) and Worthington, K., and Worthington, V. (2011). Worthington Biochemical Corporation. As of 5 Dec. 2014(worthington-biochem.com/pap/default.html)

1. A method of preparing a fermented milk product, the method comprising:
(a) treating a milk substrate with a low pH sensitive peptidase and a microorganism; and
(b) allowing the treated milk substrate to ferment to produce the fermented milk product.

2. A method according to claim 1, wherein the low pH sensitive peptidase belongs to Enzyme Commission (E.C.) No. 3.4.17, 3.4.21 or 3.4.24.

3. A method according to claim 1, wherein the low pH sensitive peptidase is from family M4.

4. A method according to claim 3 wherein the low pH sensitive peptidase is a metalloprotease.

5. A method according to claim 4 wherein the low pH sensitive peptidase comprises a mature protein excluding a signal sequence, or where the low pH sensitive peptidase comprises a full length protein including a signal sequence.

6. A method according to claim 5 wherein the low pH sensitive peptidase is a bacterial peptidase, a fungal peptidase, an archaeal peptidase, an artificial peptidase or a functional variant thereof.

7. A method according to claim 6 wherein the low pH sensitive peptidase is a bacterial metalloprotease, a fungal metalloprotease, an archaeal metalloprotease, an artificial metalloprotease or a functional variant thereof.

8. A method according claim 7, wherein the low pH sensitive peptidase comprises a polypeptide having an amino acid sequence of SEQ ID NO: 1, a polypeptide having at least 75% sequence identity thereto, or a functional variant thereof.

9. A method according to claim 7, wherein the low pH sensitive peptidase comprises a polypeptide having an amino acid sequence of SEQ ID NO: 2, a polypeptide having at least 75% sequence identity thereto, or a functional variant thereof.

10. A method according to claim 7, wherein the low pH sensitive peptidase comprises a polypeptide having an amino acid sequence of SEQ ID NO: 3, a polypeptide having at least 75% sequence identity thereto, or a functional variant thereof.

11. A method according to claim 7, wherein the low pH sensitive peptidase comprises a polypeptide having an amino acid sequence of SEQ ID NO:4, a polypeptide having at least 75% sequence identity thereto, or a functional variant thereof.

12. A method according to claim 11, wherein the low pH sensitive peptidase comprises a polypeptide lacking a signal sequence.

13. A method according to claim 12, wherein the microorganism is a lactic acid bacterium.

14. A method according to claim 13, wherein the microorganism is of the genus Streptococcus, Lactococcus, Lactobacillus, Leuconostoc, Pseudoleuconostoc, Pediococcus, Propionibacterium, Enterococcus, Brevibacterium, Bifidobacterium or any combination thereof.

15. A method according to claim 14, wherein the milk substrate is additionally treated with a glycosidase.

16. A method according to claim 15, wherein the glycosidase is an N-linked glycosidase or an O-linked glycosidase.

17. A method according to claim 16, wherein the glycosidase is selected from SEQ ID No. 10, SEQ ID NO:11, SEQ ID NO:12, SEQ ID NO:13, and a glycosidase having at least 75% sequence identity to any thereof.

18. A method according to claim 17, wherein the peptidase is dosed at an amount of 0.1 ug to 1000 ug per kilo of milk substrate, preferably 1-100 ug/kg, and most preferably 10 ug/kg.

19. A method according to claim 17, wherein the peptidase is dosed at an amount of 0.1-1000 units of peptidase activity per 100 mL of inoculated milk substrate, preferably 1-100 units, and most preferably 0.1-1 units.

20. A method according to claim 19, wherein the milk substrate is pasteurised at least once prior to step (a).

21. A method according to claim 20, wherein the fermented milk product is stirred during or following the fermentation step (b).

22. A method according to claim 21, wherein the fermented milk product is cooled following stirring.

23. (canceled)

24. A fermented milk product comprising a low pH sensitive peptidase and a microorganism.

25. A fermented milk product according to claim 24, wherein the low pH sensitive peptidase belongs to Enzyme Commission (E.C.) No. 3.4.17, 3.4.21 or 3.4.24.

26. A fermented milk product according to claim 25, wherein the low pH sensitive peptidase is from family M4.

27. A fermented milk product according to claim 26 wherein the low pH sensitive peptidase is a metalloprotease.

28. A fermented milk product according to claim 27 wherein the low pH sensitive peptidase is a bacterial peptidase, a fungal peptidase, an archaeal peptidase, an artificial peptidase or a functional variant thereof.

29. A fermented milk product according to claim 27 wherein the low pH sensitive peptidase is a bacterial metalloprotease, a fungal metalloprotease, an archaeal metalloprotease, an artificial metalloprotease or a functional variant thereof.

30. A fermented milk product according to claim 29, wherein the low pH sensitive peptidase comprises a polypeptide having an amino acid sequence selected from SEQ ID NO: 1, SEQ ID NO: 2, SEQ ID NO: 3, and SEQ ID NO: 4, or a polypeptide having at least 75%, sequence identity thereto, or a functional variant thereof.

31. A fermented milk product according to claim 30, wherein the microorganism is a lactic acid bacterium.

32. A fermented milk product according to claim 31, wherein the microorganism is of the genus Streptococcus, Lactococcus, Lactobacillus, Leuconostoc, Pseudoleuconostoc, Pediococcus, Propionibacterium, Enterococcus, Brevibacterium, and Bifidobacterium or any combination thereof.

33. A fermented milk product according to claim 32, which additionally comprises a glycosidase.

34-38. (canceled)
